(19) United States
(12) Patent Application Publication
(10) Pub. No.: US 2015/0037525 A1
(43) Pub. Date: Feb. 5, 2015

(54) METHOD FOR MANUFACTURING HOLLOW MOLDED ARTICLE, HOLLOW MOLDED ARTICLE, AND MANUFACTURING APPARATUS

(71) Applicant: Sumitomo Chemical Company, Limited, Tokyo (JP)

(72) Inventors: Mitsuo Maeda, Tsukuba-shi (JP); Hisashi Suzuki, Tsukuba-shi (JP); Hideaki Nezu, Tsukuba-shi (JP)

(73) Assignee: SUMITOMO CHEMICAL COMPANY, LIMITED, Tokyo (JP)

(21) Appl. No.: 14/387,717

(22) PCT Filed: Mar. 28, 2013
(86) PCT No.: PCT/JP2013/059308

§ 371 Date: Sep. 24, 2014

(30) Foreign Application Priority Data
Mar. 29, 2012 (JP) 2012-077649
Mar. 29, 2012 (JP) 2012-077993

(51) Int. Cl. B29C 45/00; B29D 22/00; B29C 45/72

(52) U.S. Cl. CPC B29C 45/0003; B29C 45/7207; B29D 22/003; B29K 2033/04
USPC 428/36.92; 264/478; 425/174.4

(57) ABSTRACT

A hollow molded article is formed by laser welding a container and a lid. The container and lid are each injection molded from a material containing a thermoplastic resin and have gate marks, formed during molding. The thermoplastic resin is oriented in the flow direction in a molten state and solidified. The entire gate mark of the container is located on its outer or bottom surface, but is present in a position other than an area at two-thirds or less of the distance from the center of gravity to the outer periphery of the bottom surface. The entire gate mark of the lid is located on its upper, side, or lower surface, but is present in a position other than areas at two-thirds or less of the distances from the centers of gravity of the upper and lower surfaces of the lid to the outer peripheries of the respective surfaces.

### TECHNICAL FIELD

The present invention relates to a method of manufacturing a hollow molded article, a hollow molded article and a manufacturing apparatus.

Priority is claimed on Japanese Patent Application No. 2012-077649, filed Mar. 29, 2012, and Japanese Patent Application No. 2012-077993, filed Mar. 29, 2012, the contents of which are incorporated herein by reference.

Conventionally, a molded body made of a resin that has an accommodating space therein and is hermetically sealed (hereinafter, referred to as a hollow molded article in some cases) has been known. Specific examples of such molded bodies include a hollow package obtained by filling the inside of a container having an insulating property with components, such as electronic circuits, and sealing with a cap (lid).

As a method for producing such a hollow molded article, a method of integrating the container and the cap by laser welding has been known (for example, see Patent Document 1).

### CITATION LIST

### Patent Document

[Patent Document 1] Japanese Unexamined Patent Application, First Publication No. 2004-235484

### SUMMARY OF INVENTION

### Technical Problem

With such a hollow molded article, in order to prevent the components to be sealed inside from being damaged by the moisture or oxygen in the atmosphere, a high level of airtightness is required at times, and further improvements have been demanded, as compared to those previously known.

For this reason, a method for manufacturing a hollow molded article having high airtightness has been demanded.

In addition, there has been a demand for a manufacturing apparatus which is capable of easily manufacturing a hollow molded article having high airtightness.

The present invention has been made in view of the above circumstances, and has an object of providing a hollow molded article exhibiting a high level of airtightness. In addition, another object is to provide a method for manufacturing such a hollow molded article.

Further, yet another object is to provide a hollow molded article produced by such a method for manufacturing a hollow molded article.

Furthermore, yet another object is to provide a manufacturing apparatus which is capable of manufacturing a hollow molded article having excellent airtightness.

### Solution to Problem

[1] A first aspect of the present invention provides a hollow molded article which is a hollow molded article including a container and a lid for sealing the container, the hollow molded article is a hollow molded article formed by laser welding of the container and the lid; the container and the lid are each an injected molded article of a forming material containing a thermoplastic resin and include gate marks that have been formed during injection molding;

the thermoplastic resin has a property of being solidified with being oriented in a flow direction in a molten state;

the entire gate mark in the container is presented in an outer surface or bottom surface of the container, provided that the entire gate mark is present, based on a distance from the center of gravity of the bottom surface in the container to an outer periphery of the bottom surface, in a position other than an area within two-thirds or less of the distance from the center of gravity;

and the entire gate mark in the lid is presented in an upper surface, side surface, or lower surface of the lid, provided that the entire gate mark is present, based on a distance from the center of gravity of the upper surface in the lid to an outer periphery of the upper surface in a position other than an area within t two-thirds or less of the distance from the center of gravity of the upper surface, as well as, based on a distance from the center of gravity of the lower surface in said lid to an outer periphery of said lower surface, in a position other than an area within two-thirds or less of the distance from the center of gravity of the lower surface.

[2] The hollow molded article according to [1], wherein an average thickness TB of the bottom portion in the container and an average thickness TW of a side wall in the container satisfy the following formula (I):

4TB≧TW>¾TB (I).

[3] The hollow molded article according to [1] or [2], wherein the bottom surface has a polygonal shape,

at least one portion of the gate mark in the container is present in an area, taking a corner of the said bottom surface as the center thereof, within one-sixth of a distance from the corner of the bottom surface to an adjacent corner of the container,

at least one portion of the gate mark in the lid is present: in an upper surface of said lid, in an area, taking a corner of said upper surface as the center thereof, within one-sixth of a distance from the corner of the upper surface to an adjacent corner of the lid; in a lower surface of the lid, in an area, taking a corner of the lower surface as the center thereof, within one-sixth of the distance from a corner of the lower surface to an adjacent corner of the lid; or, in a side surface of the lid, in an area within one-sixth of a distance from a ridge line connecting adjacent corners of the upper and lower surfaces in the lid to an opposing ridge line.

[4] The hollow molded article according to any one of [1] to [3], wherein an outer shape is a rectangular parallelepiped shape.
[5] The hollow molded article according to any one of [1] to [4], wherein the thermoplastic resin is a liquid crystalline polyester.
[6] A second aspect of the present invention provides a method for producing a hollow molded article including: a step of injection molding into a container by using a forming material which cimprises a thermoplastic resin having a property of being solidified with being oriented in a flow direction in a molten state;

a step of injection molding into a lid by using a forming material which comprisees a thermoplastic resin having a property of being solidified with being oriented in a flow direction in a molten state; and

a step of closing an opening of the container with the lid and performing laser welding of a contact portion in which the container and the lid are brought into contact with each other;

the step of injection molding into a container including an injection molding into the container by using a mold in which a gate position is set in a manner where the entire gate mark in the container is presented in an outer surface or bottom surface of said container, provide that, the entire gate mark is present, based on a distance from the center of gravity of the bottom surface in the container to an outer periphery of the bottom surface, in a position other than an area within two-thirds or less of the distance from the center of gravity, and

the step of injection molding into a lid including an injection molding into the lid by using a mold in which a gate position is set in a manner where the entire gate mark of the lid is present in an upper surface, side surface, or lower surface of the lid, provide that, the entire gate mark is present, based on a distance from the center of gravity of the upper surface in said lid to an outer periphery of said upper surface, a position other than an area within two-thirds or less of the distance from the center of gravity of the upper surface, as well as, based on a distance from the center of gravity of the lower surface in said lid to an outer periphery of said lower surface, other than an area within two-thirds or less of said distance from the center of gravity of the lower surface.

[7] A third aspect of the present invention provides a method for producing a hollow molded article including a step in which, using a container formed by molding a forming material which comprises a thermoplastic resin and a lid formed by molding a light transmitting material, in a state where an accommodating space surrounded by side walls and a bottom portion of the container has been depressurized, laser welded is performed for sealing a contact portion where a top portion of the side walls and a peripheral portion of the lid are brought into contact, thereby obtaining a hollow molded article in a state where the accommodating space has been depressurized.
[8] The method for producing a hollow molded article according to [7], wherein following closing the container with the lid, a work space on which the container and the lid are mounted is depressurized and then laser welding is performed for sealing with the accommodating space being depressurized.
[9] The method for producing a hollow molded article according to [7], wherein following sealing the container with the lid in an environment in which pressure is reduced in advance, laser welding is performed for sealing.
[10] The method for producing a hollow molded article according to any one of [7] to [9], wherein the thermoplastic resin is a liquid crystalline polyester.
[11] The method for producing a hollow molded article according to any one of [7] to [10], wherein the light transmitting material is a forming material which comprises a liquid crystalline polyester.
[12] A fourth aspect of the present invention provides a hollow molded article produced by the method for producing a hollow molded article according to any one of [7] to [11].
[13] A fifth aspect of the present invention provides a production apparatus including: a mounting table for mounting an object to be subjected to laser welding,

a laser light source for emitting a laser beam on the object;

an opposing member facing the mounting table which is movable for changing a separation distance from the mounting table;

a wall material surrounding an area for mounting the object on the mounting table, said wall material being formed by molding a forming material which includes a resilient material into a closed circular shape, and said wall material being located between the mounting table and the opposing member;

and a pressure reducing device;

the opposing member being positioned so as to overlap with an opening of the wall material in plain view and being provided with a laser light transmitting portion which transmits said laser beam,

the mounting table and the opposing member, in a case of the separation distance being narrowed by moving the opposing member toward the mounting table, sandwiching the wall material, thereby forming a work space surrounded and sealed by the mounting table, the opposing member and the wall material,

a through hole which is connected to the work space and the pressure reducing device being provided in the mounting table, the opposing member or the wall material, and the pressure reducing device reducing the pressure of the work space through the through hole.

[14] The manufacturing apparatus according to [13], wherein the opposing member includes a heat dissipating member, which is formed from a light transmitting material and provided in the laser light transmitting portion, and a support for supporting said heat dissipating member.
[15] The manufacturing apparatus according to [13] or [14], wherein the opposing member includes a jig for holding the object on a surface facing the mounting table.

In order to solve the problems described above, a sixth aspect of the present invention provides a hollow molded article which is a hollow molded article formed by laser welding a container and a lid for sealing the container, in which the container and the lid are each an injected molded article of a forming material containing a thermoplastic resin and include gate marks that are formed during injection molding, the thermoplastic resin has a property of being oriented in a flow direction in a molten state thereof and solidified, the gate mark of the container is located on the outside of the hollow molded article, and, based on a distance from the center of gravity of a shape of a bottom surface of the container to an outer periphery of the bottom surface, is in a position excluding an area within two-thirds of the distance from the center of gravity, and the gate mark of the lid is, based on distances from the centers of gravity of planar shapes of the upper surface and lower surface of the lid to outer peripheries of planar shapes of the respective surfaces, in a position excluding areas within two-thirds of the distances from the centers of gravity of the respective surfaces.

In the sixth aspect of the present invention, it is desirable that an average thickness TB of the bottom portion in the container and an average thickness TW of a side wall in the container satisfy the following formula (I):

4TB≧TW>¾TB (I).

In the sixth aspect of the present invention, it is desirable that the bottom surface has a polygonal shape, the gate mark in the container is present in an area, taking a corner of the said bottom surface as the center thereof, within one-sixth of a distance from a corner of the bottom surface to an adjacent corner of the container, the gate mark in the lid is present: in an upper surface and lower surface of the lid, in an area, taking corners of said upper surface and lower surface as the center thereof, within one-sixth of distances from the respective corners to adjacent corners of the lid on the same surface; and, in a side surface of the lid, in an area within one-sixth of a distance from a ridge line connecting adjacent corners of the upper and lower surfaces in the lid to an opposing ridge line.

In the sixth aspect of the present invention, it is desirable that an outer shape is a rectangular parallelepiped shape.

In the sixth aspect of the present invention, it is desirable that the thermoplastic resin be a liquid crystalline polyester.

In addition, a seventh aspect of the present invention provides a method for producing a hollow molded article including a step of injection molding into a container by using a forming material which includes a thermoplastic resin having a property of being solidified with being oriented in a flow direction in a molten state; and a step of closing an opening of the container with the lid and performing laser welding of a contact portion in which the container and the lid are brought into contact with each other; wherein in the step of injection molding, the container is injection molded by using a mold in which, based on a distance from the center of gravity of the bottom surface in the container to an outer periphery of the bottom surface, a gate mark is presented in a position other than an area within two-thirds or less of the distance from the center of gravity, and also in a position located on the outside of the hollow molded article obtained by closing the container with the lid; and the lid is injection molded by using a mold in which, based on distances from the centers of gravity of planar shapes of the upper surface and lower surface of the lid to outer peripheries of planar shapes of the respective surfaces, a gate position is presented in a position other than areas within two-thirds or less of the distances from the centers of gravity of the respective surfaces.

In order to solve the problems described above, an eighth aspect of the present invention provides a method for producing a hollow molded article including a step in which, using a container formed by molding a forming material which includes a thermoplastic resin and a lid formed by molding a light transmitting material, in a state where an accommodating space surrounded by side walls and a bottom portion of the container has been depressurized, a contact portion between a top portion of the side walls and the lid is laser welded and the accommodating space has been sealed while being depressurized.

In the eighth aspect of the present invention, after closing the container with the lid, it is desirable to being performed laser welding while the accommodating space is depressurized by reducing the pressure of a work space on which the container and the lid are mounted.

In the eighth aspect of the present invention, it is desirable to being performed laser welding after sealing the container with the lid in an environment in which the pressure is reduced in advance.

In the eighth aspect of the present invention, it is desirable that the thermoplastic resin be a liquid crystalline polyester.

In a ninth aspect of the present invention, it is desirable that the light transmitting material be a forming material which includes a liquid crystalline polyester.

In addition, the ninth aspect of the present invention provides a hollow molded article manufactured by the method for manufacturing a hollow molded article.

Further, a tenth aspect of the present invention provides a production apparatus including: a mounting table for mounting an object to be subjected to laser welding, a laser light source for emitting a laser beam on the object, an opposing member facing the mounting table which is capable of relatively changing a separation distance from the mounting table, a wall material surrounding an area for mounting said object on said mounting table, said wall material being formed by molding a forming material which includes a resilient material into a closed circular shape, and, said wall material being located between said mounting table and said opposing member; wherein the opposing member is positioned so as to overlap at least with an opening of the wall material in plan view and is provided with a laser light transmitting portion which transmits the laser beam, the mounting table and the opposing member, sandwich the wall material therebetween and form a work space surrounded and sealed by the mounting table, the opposing member and the wall material, because of the separation distance being narrowed, and also the mounting table or the opposing member is separated from the wall material due to the separation distance being widened, and a through hole which is connected to the work space is provided in the mounting table, the opposing member or the wall material, and a pressure reducing device which reduces the pressure of the work space through the through hole is further included.

In the tenth aspect of the present invention, it is desirable that the opposing member include a heat dissipating member which is formed from a light transmitting material and provided in the laser light transmitting portion, and a support for supporting the heat dissipating member.

In the tenth aspect of the present invention, it is desirable that the opposing member include a jig for holding the object on a surface facing the mounting table.

### Advantageous Effects of Invention

According to the present invention, it is possible to provide a hollow molded article exhibiting a high level of airtightness. In addition, it is possible to provide a method for manufacturing such a hollow molded article. Furthermore, it is possible to provide a manufacturing apparatus capable of manufacturing a hollow molded article exhibiting excellent airtightness.

### BRIEF DESCRIPTION OF DRAWINGS

FIG. 1A is a schematic diagram showing an example of a hollow molded article of the present embodiment.

FIG. 1B is a schematic diagram showing an example of a hollow molded article of the present embodiment.

FIG. 2A is an explanatory diagram of a container capable of producing a hollow molded article of the present embodiment.

FIG. 2B is an explanatory diagram of a lid capable of producing a hollow molded article of the present embodiment.

FIG. 2C is an explanatory diagram of a lid capable of producing a hollow molded article of the present embodiment.

FIG. 3 is a diagram for explaining the effect of the gate mark positions of the container and lid.

FIG. 4 is a diagram for explaining the effect of the gate mark positions of the container and lid.

FIG. 5 is a schematic diagram showing a preferred position of the gate mark of the container exhibiting a rectangular parallelepiped shape.

FIG. 6 is a schematic diagram showing a preferred position of the gate mark of the lid exhibiting a rectangular parallelepiped shape.

FIG. 7 is a schematic vertical cross-sectional view of a container.

FIG. 8 is a schematic vertical cross-sectional view of a lid.

FIG. 9 is a schematic diagram illustrating a welding apparatus used in laser welding.

FIG. 10A is a process diagram of laser welding.

FIG. 10B is a process diagram of laser welding.

FIG. 11A is a schematic diagram showing the shape of the containers molded in Examples and Comparative Examples.

FIG. 11B is a schematic vertical cross-sectional view of the containers molded in Examples and Comparative Examples.

FIG. 11C is a schematic diagram showing the shape of the lids molded in Examples and Comparative Examples.

FIG. 11D is a schematic vertical cross-sectional view of the containers molded in Examples and Comparative Examples.

FIG. 12A is a schematic diagram showing an example of a hollow molded article produced by a manufacturing method of the present embodiment.

FIG. 12B is a schematic vertical cross-sectional view showing an example of a hollow molded article produced by a manufacturing method of the present embodiment.

FIG. 13 is a schematic diagram illustrating a manufacturing apparatus of the present embodiment.

FIG. 14A is a process diagram of a method for manufacturing a hollow molded article of the present embodiment.

FIG. 14B is a process diagram of a method for manufacturing a hollow molded article of the present embodiment.

FIG. 15A is a process diagram of a method for manufacturing a hollow molded article of the present embodiment.

FIG. 15B is a process diagram of a method for manufacturing a hollow molded article of the present embodiment.

### DESCRIPTION OF EMBODIMENTS

### Hollow Molded Article in the First Aspect of the Present Invention

A hollow molded article in the first aspect of the present invention is a hollow molded article including a container and a lid for sealing the container, which is formed by laser welding of the container and the lid, wherein the container and the lid are each an injected molded article of a formation material containing a thermoplastic resin, and include gate marks that have been formed during injection molding, the thermoplastic resin has a property of being solidified with being oriented in a flow direction in a molten state, the entire gate mark in the container is presented in an outer surface or bottom surface of the container, provided that the entire gate mark is present, based on a distance from the center of gravity of the bottom surface in the container to an outer periphery of the bottom surface, in a position other than an area within two-thirds of the distance from the center of gravity, and the entire gate mark in the lid is presented in an upper surface, side surface, or lower surface of the lid, provided that the entire gate mark is present, based on a distance from the center of gravity of the upper surface in the lid to an outer periphery of the upper surface, in a position other than an area within two-thirds of the distance from the center of gravity of the upper surface, as well as, based on a distance from the center of gravity of the lower surface in said lid to an outer periphery of said lower surface, in a position other than an area within two-thirds of the distance from the center of gravity of the lower surface.

A description is provided below in order.

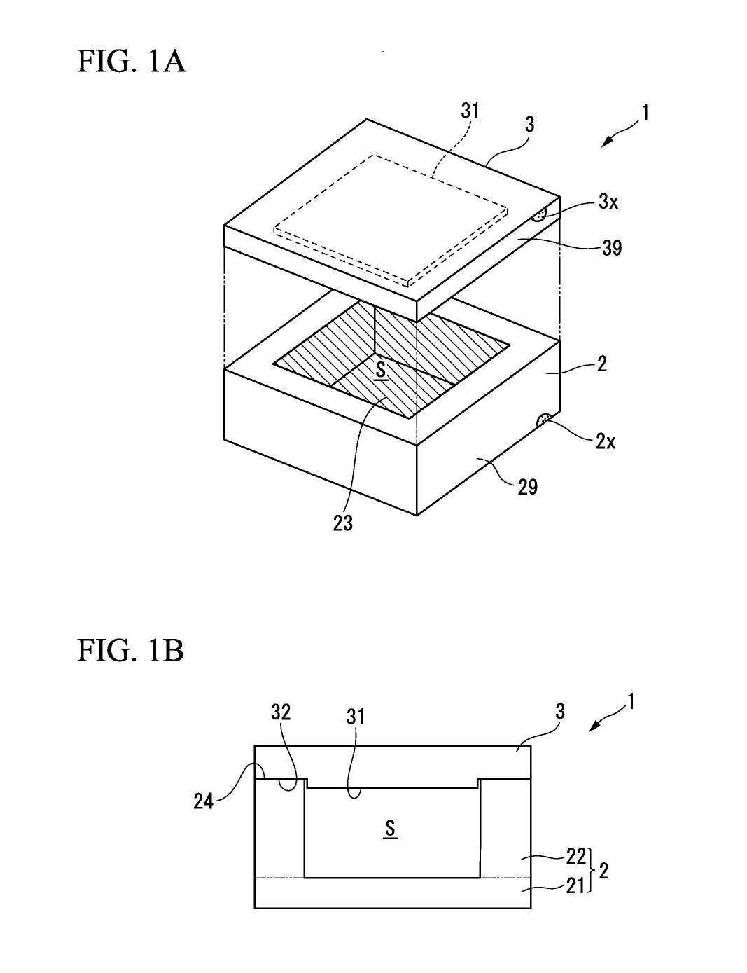

FIG. 1A and FIG. 1B are schematic diagrams showing an example of a hollow molded article of the first aspect of the present invention, and FIG. 1A is an exploded perspective view while FIG. 1B is a schematic vertical cross-sectional view. As shown in FIG. 1A and FIG. 1B, a hollow molded article 1 of the present embodiment includes a container 2 and a lid 3 that are molded articles formed by injection molding. In the hollow molded article 1 of the present embodiment, the container 2 and the lid 3 are joined by employing a laser welding method.

The container 2 is a molded article surrounded by a bottom portion 21 and side walls 22 that intersect with the bottom portion 21 and has an accommodating space S in which an opening 23 is formed on one side. The shape of the container 2 can be appropriately set in accordance with the shape of the components to be accommodated in the accommodating space S. For example, in the general case where a semiconductor device having a rectangular parallelepiped shape is accommodated in the accommodating space S, as shown in FIG. 1A and FIG. 1B, it is preferable to make the accommodating space S to have a rectangular parallelepiped shape with the bottom portion 21 of the rectangular parallelepiped being perpendicular to the side walls 22. In addition, it may be made into a hollow molded article having a cylindrical outer shape or a prism outer shape in which the bottom surface shape is a polygonal shape. Furthermore, it may be made into a hollow molded article having an outer shape of a truncated cone or polygonal frustum.

In the present description, the “bottom portion” of the container refers to a portion forming the bottom of the container, and the “side wall” of the container refers to a portion formed on the bottom portion of the container, which is the part that constitutes the wall of the container (a portion which is substantially perpendicular to the bottom of the container). The “bottom surface” of the container refers to a surface of the container on the lower side when sealing the container with the lid so that the lid comes on top of the container, and the “outer surface” of the container refers to a surface intersecting with the bottom surface, which is the side surface of the container.

The container 2 contains a coloring agent for absorbing laser light and converting the energy into heat.

Examples of the coloring agent include carbon black, monoazo dyes, anthraquinone dyes, perylene dyes, phthalocyanine dyes, nigrosine dyes, titanium black, black iron oxide, yellow iron oxide, red iron oxide, cadmium yellow, nickel titanium yellow, strontium yellow, aqueous chromium oxide, chromium oxide, cobalt aluminate and ultramarine blue, and one, or two or more types of these may be used. Among these, because of their high heat resistance, carbon black, titanium black and black iron oxide are preferred.

Such coloring agents are preferably contained in an amount of 0.01 to 10 parts by weight, and more preferably from 0.05 to 5 parts by weight, with respect to the total amount of the container 2 (100 parts by weight).

Further, the container 2 may contain inorganic fillers, various additives, or the like, as long as the effects of the present invention are not impaired.

It is also possible to embed a terminal for connecting the accommodating space S and the outside of the container 2 in the side wall 22 during injection molding of the container 2. For example, it is possible to form the container 2 having an external connection terminal by inserting a lead frame which is processed into a terminal shape in advance into a mold, followed by injection molding.

The lid 3 is a plate-shaped molded body having the same shape as that of the container 2 in plan view. In the drawing, like the container 2 having a rectangular shape in a plan view, the lid 3 has a rectangular shape in plan view. In addition, on the side facing the container 2 in the lid 3 (that is, the lower surface side), a convex portion 31 which fits in an opening 23 of the container 2 is provided in the central portion. In the drawing, the convex portion 31 also has a rectangular shape in plan view in accordance with the shape of the opening 23 of the container 2.

In the present description, an “upper surface” of the lid refers to the surface of the lid facing upward when the container is sealed with the lid so that the lid is placed on top of the container, a “lower surface” of the lid refers to the surface of the lid facing downward when the container is sealed with the lid so that the lid is placed on top of the container, and a “side surface” of the lid refers to a plane intersecting with these surfaces.

In the present embodiment, although the shape of the lid 3 in plan view is configured to be the same in response to the shape of the container 2 in plan view and the shape of the opening 23, the shapes of the container 2 and the lid 3 in plan view may be different. Further, the central portion of the lid 3 may be raised upward or may be recessed.

Needless to say, a flat plate-shaped lid that does not have a convex portion 31, like the lid 3 shown in the drawing, may be used.

The lid 3 may contain inorganic fillers, various additives, or the like, as long as the effects of the present invention are not impaired.

The container 2 and the lid 3 are bringing the top portion 24 of the side wall 22 of the container 2 into contact with a peripheral portion 32 surrounding the convex portion 31 of the lid 3, while the convex portion 31 of the lid 3 is fitted in the opening 23 of the container 2, and a contact portion is joined by using a laser welding method. In the hollow molded article of the present embodiment, in those cases where the container 2 and the lid 3 are welded by a laser welding method, portions of each are melted and joined. For this reason, it is preferable to use forming materials having the same melting point or flow-starting temperature for the container 2 and the lid 3, and it is more preferable to use the same material, apart from the presence or absence of the addition of the coloring agent described above.

As the material for forming the container 2 and the lid 3 in the present embodiment, it is possible to use a resin material that includes an aromatic ring in the main chain skeleton and has a linear structure. Although such resin materials are easily oriented at the time of flowing, in the hollow molded article of the present embodiment, it is possible to configure a hollow molded article having high airtightness by using such resin materials.

Specific examples of the resin materials that can be used include polycarbonate resins, aromatic polyamides, polyphenylene ether resins, polyphenylene sulfide resins, polysulfone resins, polyarylate resins, polyetherimide resins, polyether sulfone resins, polyether ketone resins, liquid crystalline polyesters, polyamideimide resins and polyimide resins, and among these, liquid crystalline polyesters are preferred since the fluidity, heat resistance, rigidity and gas barrier properties are favorable.

### (Liquid Crystalline Polyester)

A liquid crystalline polyester which can be used as a forming material of the hollow molded article of the present embodiment is a liquid crystalline polyester exhibiting liquid crystallinity in a molten state and is preferably one that melts at a temperature of 450° C. or less. The liquid crystalline polyester may be a liquid crystalline polyester amide, a liquid crystalline polyester ether, a liquid crystalline polyester carbonate or a liquid crystalline polyester imide. The liquid crystalline polyester is preferably a wholly aromatic liquid crystalline polyester which is formed by using only aromatic compounds as raw material monomers.

Typical examples of the liquid crystalline polyester include:

(I) liquid crystalline polyesters obtained by polymerization (polycondensation) of at least one type of compound selected from the group consisting of aromatic diols, aromatic hydroxyamines and aromatic diamines with an aromatic hydroxycarboxylic acid and an aromatic dicarboxylic acid;

(II) liquid crystalline polyesters obtained by polymerization of a plurality of types of aromatic hydroxycarboxylic acids;

(III) liquid crystalline polyesters obtained by polymerization of at least one type of compound selected from the group consisting of aromatic diols, aromatic hydroxyamines and aromatic diamines with an aromatic dicarboxylic acid; and

(IV) liquid crystalline polyesters obtained by polymerization of a polyester, such as polyethylene terephthalate, with an aromatic hydroxycarboxylic acid. Here, each of the aromatic hydroxycarboxylic acids, aromatic dicarboxylic acids, aromatic diols, aromatic hydroxyamines and aromatic diamines, independently, may be replaced, partially or entirely, by using the polymerizable derivatives thereof instead.

An aromatic hydroxycarboxylic acid is a compound obtained by replacing two hydrogen atoms, from an aromatic compound, that are bonded to the aromatic ring thereof with a hydroxyl group and a carboxyl group, respectively.

An aromatic dicarboxylic acid is a compound obtained by replacing, from an aromatic compound, two hydrogen atoms that are bonded to the aromatic ring thereof with carboxyl groups, respectively.

An aromatic diol is a compound obtained by replacing two hydrogen atoms, from an aromatic compound, that are bonded to the aromatic ring thereof with hydroxyl groups, respectively.

An aromatic hydroxylamine is a compound obtained by replacing, from an aromatic compound, two hydrogen atoms that are bonded to the aromatic ring thereof with a hydroxyl group and an amino group, respectively.

An aromatic diamine is a compound obtained by replacing, from an aromatic compound, two hydrogen atoms that are bonded to the aromatic ring thereof with amino groups, respectively.

Examples of the polymerizable derivatives of a compound having a carboxyl group, such as an aromatic hydroxycarboxylic acid and an aromatic dicarboxylic acid, include esters obtained by converting the carboxyl group into an alkoxy carbonyl group or an aryloxy carbonyl group, acid halides obtained by converting the carboxyl group into a haloformyl group, and acid anhydrides obtained by converting the carboxyl group into an acyloxy carbonyl group.

Examples of the polymerizable derivatives of a compound having a hydroxyl group, such as an aromatic hydroxycarboxylic acid, an aromatic diol and an aromatic hydroxylamine, include acylated products obtained by converting the hydroxyl group into an acyloxyl group by acylation.

Examples of the polymerizable derivatives of a compound having an amino group, such as an aromatic hydroxylamine and an aromatic diamine, include those (acylated products) obtained by converting the amino group into an acylamino group by acylation.

The liquid crystalline polyester preferably has a repeating unit represented by the following general formula (1) (hereinafter, sometimes referred to as a “repeating unit (1)”), and more preferably has the repeating unit (1), a repeating unit represented by the following general formula (2) (hereinafter, sometimes referred to as a “repeating unit (2)”) and a repeating unit represented by the following general formula (3) (hereinafter, sometimes referred to as a “repeating unit (3)”).

—O—Ar¹—CO— (1)

—CO—Ar²—CO— (2)

—X—Ar³—Y— (3)

(In the formula, Ar¹ represents a phenylene group, a naphthylene group or a biphenylene group; each of Ar² and Ar³ independently represents a phenylene group, a naphthylene group, a biphenylene group or a group represented by the following general formula (4); each of X and Y independently represents an oxygen atom or an imino group; and one or more hydrogen atoms in the aforementioned Ar¹, Ar², and Ar³ may be each independently substituted with a halogen atom, an alkyl group or an aryl group.)

—Ar⁴—Z—Ar⁵— (4)

(In the formula, each of Ar⁴ and Ar⁵ independently represents a phenylene group or a naphthylene group; and Z represents an oxygen atom, a sulfur atom, a carbonyl group, a sulfonyl group or an alkylidene group.)

Examples of the halogen atom that can be substituted with the hydrogen atom in the aforementioned group represented by Ar¹, Ar² or Ar³ include a fluorine atom, a chlorine atom, a bromine atom and an iodine atom.

The alkyl group that can be substituted with the hydrogen atom in the aforementioned group represented by Ar¹, Ar² or Ar³ preferably has 1 to 10 carbon atoms, and examples thereof include a methyl group, an ethyl group, an n-propyl group, an isopropyl group, an n-butyl group, an isobutyl group, an s-butyl group, a t-butyl group, an n-hexyl group, an n-heptyl group, a 2-ethylhexyl group, an n-octyl group, a nonyl group and an n-decyl group.

The aryl group that can be substituted with the hydrogen atom in the aforementioned group represented by Ar¹, Ar² or Ar³ preferably has 6 to 20 carbon atoms, and examples thereof include monocyclic aromatic groups, such as a phenyl group, an o-tolyl group, an m-tolyl group and a p-tolyl group, and condensed ring aromatic groups such as a 1-naphthyl group and a 2-naphthyl group.

In those cases where the hydrogen atom in the aforementioned group represented by Ar¹, Ar² or Ar³ is substituted with these groups, the number of substitution is, each independently, preferably 1 or 2, and more preferably 1, for each of the aforementioned group represented by Ar¹, Ar² or Ar³.

Examples of the alkylidene group include a methylene group, an ethylidene group, an isopropylidene group, an n-butylidene group and a 2-ethylhexylidene group, and the number of carbon atoms thereof is preferably from 1 to 10.

The repeating unit (1) is a repeating unit derived from a given aromatic hydroxycarboxylic acid. As the repeating unit (1), a repeating unit in which Ar¹ represents a p-phenylene group (that is, a repeating unit derived from p-hydroxybenzoic acid) and a repeating unit in which Ar¹ represents a 2,6-naphthylene group (that is, a repeating unit derived from 6-hydroxy-2-naphthoic acid) are preferred.

The repeating unit (2) is a repeating unit derived from a given aromatic dicarboxylic acid. As the repeating unit (2), a repeating unit in which Ar^{e} represents a p-phenylene group (that is, a repeating unit derived from terephthalic acid), a repeating unit in which Ar² represents an m-phenylene group (that is, a repeating unit derived from isophthalic acid), a repeating unit in which Ar^{e} represents a 2,6-naphthylene group (that is, a repeating unit derived from 2,6-naphthalene dicarboxylic acid) and a repeating unit in which Ar² represents a diphenyl ether-4,4′-diyl group (that is, a repeating unit derived from diphenyl ether-4,4′-dicarboxylic acid) are preferred.

The repeating unit (3) is a repeating unit derived from a given aromatic diol, aromatic hydroxylamine or aromatic diamine. As the repeating unit (3), a repeating unit in which Ar³ represents a p-phenylene group (that is, a repeating unit derived from hydroquinone, p-aminophenol or p-phenylenediamine) and a repeating unit in which Ar³ represents a 4,4′-biphenylylene group (that is, a repeating unit derived from 4,4′-dihydroxybiphenyl, 4-amino-4′-hydroxybiphenyl or 4,4′-diaminobiphenyl) are preferred.

The content of the repeating unit (1) is, with respect to the total amount of all the repeating units that constitute the liquid crystalline polyester (that is, a value which is obtained by determining an amount equivalent to the amount of material (mol) of each repeating unit by dividing the mass of each of the repeating units constituting the liquid crystalline polyester with the formula weight of each of the repeating units, and then summing these values), preferably at least 30 mol %, more preferably from 30 to 80 mol %, still more preferably from 40 to 70 mol %, and particularly preferably from 45 to 65 mol %.

The content of the repeating unit (2) with respect to the total amount of all the repeating units that constitute the liquid crystalline polyester is preferably not more than 35 mol %, more preferably from 10 to 35 mol %, still more preferably from 15 to 30 mol %, and particularly preferably from 17.5 to 27.5 mol %.

The content of the repeating unit (3) with respect to the total amount of all the repeating units that constitute the liquid crystalline polyester is preferably not more than 35 mol %, more preferably from 10 to 35 mol %, still more preferably from 15 to 30 mol %, and particularly preferably from 17.5 to 27.5 mol %.

For example, when the liquid crystalline polyester is constituted of the repeating unit (1), the repeating unit (2) and the repeating unit (3), it is preferable that the content of the repeating unit (1) be 30 mol % or more and 80 mol % or less, the content of the repeating unit (2) be 10 mol % or more and 35 mol % or less, and the content of the repeating unit (3) be 10 mol % or more and 35 mol % or less.

As the content of the repeating unit (1) increases, it is easy to improve the melt fluidity, heat resistance, strength and rigidity of the liquid crystalline polyester, but if the content is too high, the melting temperature and melt viscosity easily increase, and also the temperature required for molding easily increases.

The ratio of the content of the repeating unit (2) and the content of the repeating unit (3) is expressed as [content of the repeating unit (2)]/[content of the repeating unit (3)] (mol/mol) and is preferably from 0.9/1 to 1/0.9, more preferably from 0.95/1 to 1/0.95, and even more preferably from 0.98/1 to 1/0.98.

The liquid crystalline polyester may include two or more repeating units (1) to (3) each independently. Further, although the liquid crystalline polyester may have a repeating unit other than the repeating units (1) to (3), the content is preferably 10 mol % or less and more preferably 5 mol % or less, with respect to the total amount of all repeating units constituting the liquid crystalline polyester.

The liquid crystalline polyester preferably has, as the repeating unit (3), a repeating unit in which each of X and Y represents an oxygen atom, i.e., a repeating unit derived from a predetermined aromatic diol, and more preferably has, as the repeating unit (3), only repeating units in which each of X and Y represents an oxygen atom. By doing so, the melt viscosity of the liquid crystalline polyester easily decreases.

The liquid crystalline polyester is preferably produced by melt polymerizing the raw material monomers corresponding to the repeating unit that constitute the polyester and subjecting the resulting polymerized product (that is, prepolymer) to solid state polymerization.

As a result, it is possible to manufacture, with good operability, a liquid crystalline polyester of high molecular weight with high heat resistance, strength and rigidity. The melt polymerization may be carried out in the presence of a catalyst, and examples of the catalyst in this case include metallic compounds, such as magnesium acetate, stannous acetate, tetrabutyl titanate, lead acetate, sodium acetate, potassium acetate and antimony trioxide, and nitrogen-containing heterocyclic compounds, such as 4-(dimethylamino)pyridine and 1-methylimidazole, and nitrogen-containing heterocyclic compounds are preferably used.

The liquid crystalline polyester preferably has a flow starting temperature of at least 270° C., more preferably from 270° C. or more to 400° C. or less, and even more preferably from 280° C. to 380° C. or less. The higher the flow starting temperature, the more easily the heat resistance and the strength and rigidity can be improved, but if the flow starting temperature is too high, then a high temperature is required for melting, which is likely to result in the thermal deterioration during molding or an increase in the viscosity during melting to reduce the fluidity.

The “flow starting temperature” is also referred to as the flow temperature or the fluidizing temperature, which is a temperature at which the viscosity is 4,800 Pa·s (48,000 poise) when the liquid crystalline polyester is melted and extruded from a nozzle having an inner diameter of 1 mm and a length of 10 mm, using a capillary rheometer, under a loading of 9.8 MPa (100 kgf/cm²), while raising the temperature at a rate of 4° C./min, and which serves as a measure of the molecular weight of the liquid crystalline polyester (see “Liquid Crystal Polymers—synthesis, molding and applications—”, edited by Naoyuki Koide, published by CMC Publishing Co., Ltd., Jun. 5, 1987, p. 95).

### (Gate Mark)

It is preferable that each of the container 2 and the lid 3 has a gate mark at the time of injection molding at a position on the outside of a hollow molded article 1. The term “outside” refers to an outer surface of the hollow molded article 1, which is a region including an outer surface and a bottom surface in the container, and is a region including a top surface and a side surface in the lid. In the container 2 shown in FIG. 1A, there is a gate mark 2x at the time of injection molding in a lower portion of an outer surface 29 of the side wall and the vicinity of a corner. In addition, in the lid 3, there is a gate mark 3x at the time of injection molding in the vicinity of a corner of a side surface 39. In the hollow molded article 1 of the present embodiment, it is possible to use the container 2 and the lid 3 that have gate marks in such positions.

In a mold of the container and lid, a gate for injecting a forming material into the mold is provided. During injection molding, the forming material flows from the gate into the mold. At this time, because the flow direction at a position corresponding to the gate is different from the peripheral flow direction (that is, because the peripheral flow direction will be a flow direction perpendicular to the flow direction at the position corresponding to the gate), after the forming material has solidified, only the position corresponding to the gate is solidified in different orientation from the surroundings. Because the orientation is different from that of the surroundings, it is possible to visually recognize the region corresponding to the gate. In the present description, this region that can be visually recognized will be defined as a “gate mark”. The shape of the gate mark is not particularly limited as long as the shape corresponds to the cross-sectional shape of the gate. For example, the gate mark may be a protrusion made by the solidified forming material projected from the outer surface.

In the present description, the phrase “entire gate mark” refers to the entire region corresponding to the gate, and the phrase “at least a portion of the gate mark” refers to at least a portion of the region corresponding to the gate.

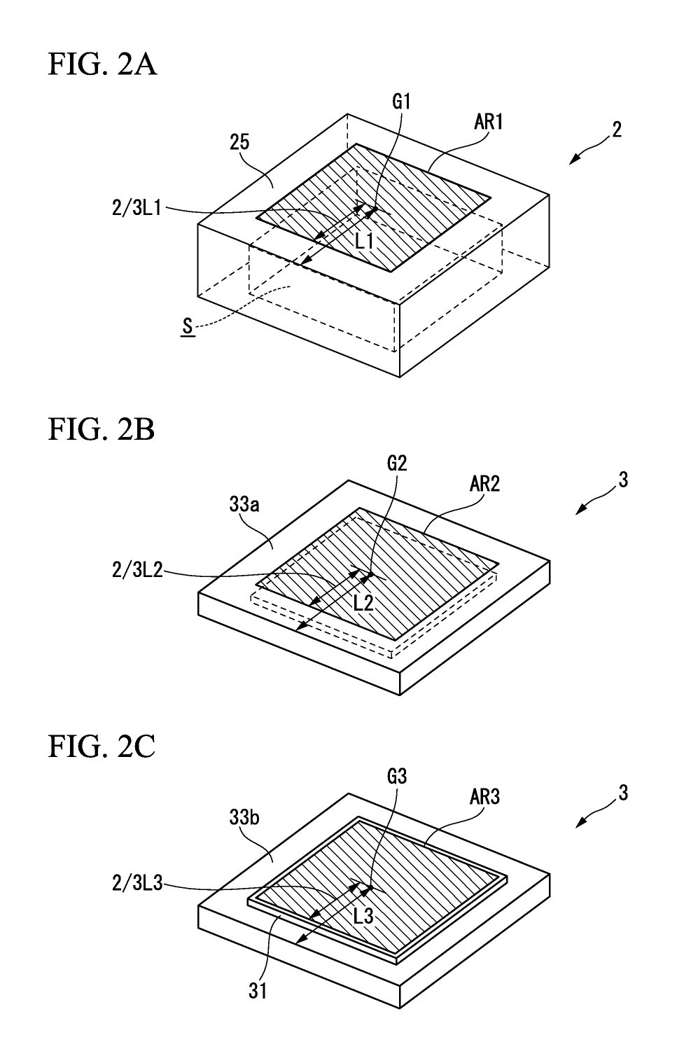

The container and lid for manufacturing the hollow molded article 1 of the present embodiment are not limited to those having the gate marks at the positions as shown in FIG. 1A. FIG. 2A, FIG. 2B and FIG. 2C are explanatory diagrams of the container and lid capable of producing the hollow molded article 1 of the present embodiment, which are diagrams illustrating the positions of the gate marks.

FIG. 2A is a schematic perspective view of the container as seen from the bottom surface side, FIG. 2B is a schematic perspective view of the lid as seen from the upper surface side, and FIG. 2C is a schematic perspective view of the lid as seen from the lower surface side.

As shown in FIG. 2A, in the container 2 constituting the hollow molded article 1 of the present embodiment, based on a distance L1 from the center of gravity G1 of the bottom surface of the container 2 to an outer periphery of the bottom surface 25, the entire gate mark is present in a position excluding an area AR1 within two-thirds of the distance L1 from the center of gravity G1. In FIG. 2A, the area AR1 in which the gate mark of the container 2 must not be located is shown by oblique lines.

In the present description, the phrase “distance to the outer periphery” refers to a distance from the center of gravity to any point on the outer circumference.

In the present description, the phrase “the center of gravity of the surface” refers to a point in the surface at which the primary moment is zero. In addition, when the surface has a rectangular shape, it refers to the intersection of diagonal lines.

Further, as shown in FIG. 2B, in an upper surface 33a of the lid 3 constituting the hollow molded article 1 of the present embodiment, based on a distance L2 from the center of gravity G2 of the upper surface 33a to an outer periphery of the upper surface 33a, the entire gate mark is present in a position excluding an area within two-thirds of the distance from the center of gravity G2. In FIG. 2B, an area AR2 in which the gate mark of the lid 3 must not be located is shown by oblique lines.

Further, as shown in FIG. 2C, in a lower surface 33b of the lid 3 constituting the hollow molded article 1 of the present embodiment, based on a distance L3 from the center of gravity G3 of the lower surface 33b of the lid 3 to an outer periphery of the lower surface 33b, the entire gate mark is present in a position excluding an area within two-thirds of the distance from the center of gravity G3. In FIG. 2C, an area AR3 in which the gate mark of the lid 3 must not be located is shown by oblique lines.

When the gate marks are present in such positions in the container 2 and the lid 3, this means that the container 2 and the lid 3 have been injection-molded using a mold having gates that correspond to the positions of these gate marks.

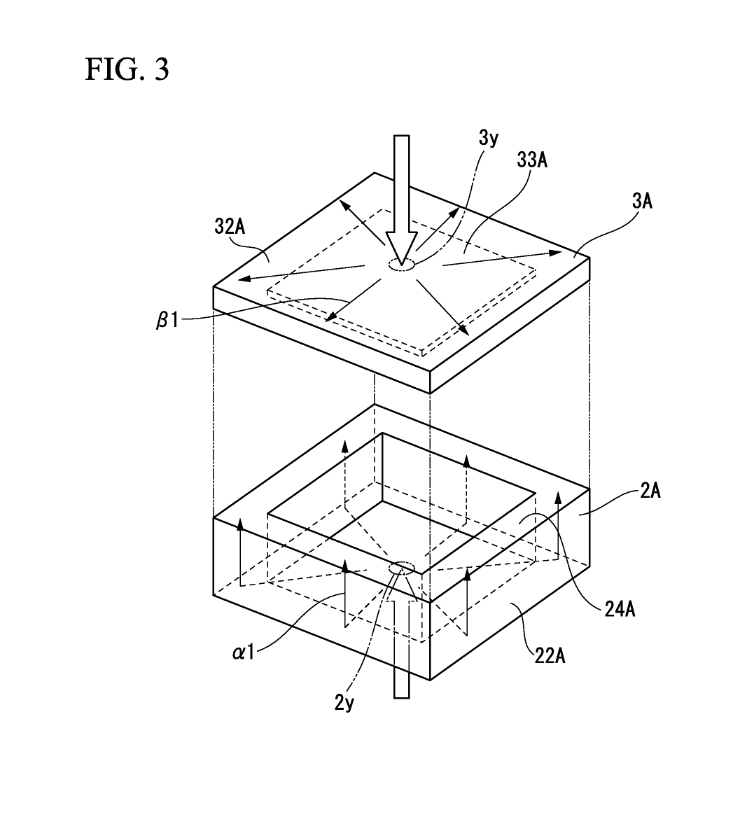

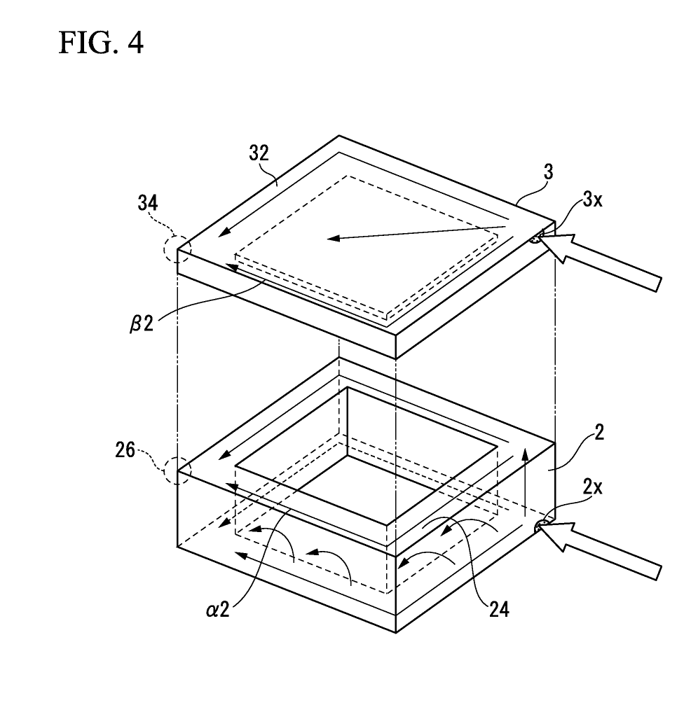

FIGS. 3 and 4 are diagrams for explaining the effects due to the positions of the gate marks of the container and the lid. FIG. 3 is a schematic diagram showing the case where the gate marks are present within the areas AR1 and AR2 shown in FIG. 2A and FIG. 2B, and FIG. 4 is a schematic diagram showing the case where the gate marks are present on the outside of the areas AR1 and AR2 shown in FIG. 2A and FIG. 2B. The container and lid shown in FIG. 4 correspond to those shown in FIG. 1A and FIG. 1B. In FIGS. 3 and 4, the flow of the molten resin at the time of molding is indicated by the arrows.

First, as shown in FIG. 3, when injection molding is carried out using a mold in which the gate position (indicated by the reference symbol 2y in the drawing) is set at a position which is to become the center of the bottom surface of a container 2A, the molten resin spreads radially from the gate, and then, for example, as shown by the arrow indicated by the reference symbol α1, flows toward a top portion 24A of a side wall 22A. On the other hand, when injection molding is carried out using a mold in which the gate position (indicated by the reference symbol 3y in the drawing) is set at a position which is to become the center of an upper surface 33A of a lid 3A, the molten resin spreads radially from the gate, and, for example, as shown by the arrow indicated by the reference symbol β1, flows toward a peripheral portion 32A.

Then, as shown by the arrows indicated by the reference symbols α1 and β1, in the top portion 24A of the container 2A and in the peripheral portion 32A of the lid 3A, which are the portions where the container 2A and the lid 3A are welded, many portions are generated, in which the flow directions of the resins at the time of molding intersect with each other.

The resin used as a material for forming the hollow molded article of the present embodiment is oriented and solidified in the flow direction of the resin at the time of melting. For this reason, in the case of a gate position as shown in FIG. 3, in the top portion 24A of the container 2A and in the peripheral portion 32A of the lid 3A, which are the portions where the container 2A and the lid 3A are welded, the orientation directions of the resins are different from each other. The inventors of the present invention have found that when the members in which the resins are in such orientation states are welded together, sufficient strength cannot be achieved in the welded portion, and, as a result, the obtained hollow molded article is easily damaged and exhibit low airtightness.

On the other hand, as shown in FIG. 4, when injection molding is carried out using a mold in which the gate position is set at a position which is to become a gate mark 2x of the container 2, the molten resin flows toward the corner on the diagonal side (indicated by the reference symbol 26) with respect to the gate. Then, as shown by an arrow indicated by the reference symbol α2, many of the resins flowing in the vicinity of the top portion 24 of the side wall 22 flows along the top portion 24 in the surface direction of the top portion 24.

In addition, when injection molding is carried out a using mold in which the gate position is set at a position which is to become a gate mark 3x of the lid 3, the molten resin flows toward the corner on the diagonal side (indicated by the reference symbol 34) with respect to the gate. Then, as shown by an arrow indicated by the reference symbol β2, many of the resins flowing in the vicinity of the peripheral portion 32 flows along the outer periphery of the lid 3.

Then, as shown by the arrows indicated by the reference symbols α2 and β2, in the top portion 24 of the container 2 and in the peripheral portion 32 of the lid 3, which are the portions where the container 2 and the lid 3 are welded, many portions are generated, in which the flow directions of the resins at the time of molding are the same direction. In such places, the orientation directions of the resins are aligned with each other. The inventors of the present invention have found that when the container 2 and the lid 3 in which the resins are in such orientation states are welded together, sufficient strength can easily be achieved in the welded portion, and, as a result, it is possible to configure a hollow molded article which is hardly damaged and exhibits high airtightness.

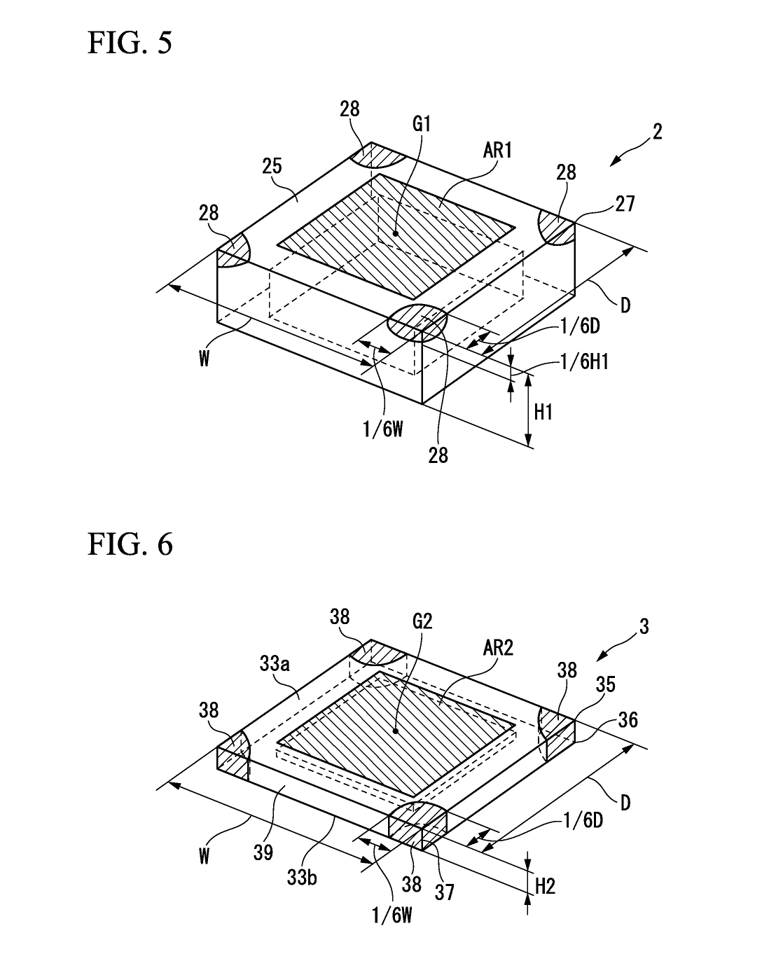

FIG. 5 is a schematic diagram showing a suitable position for the gate mark of a container exhibiting a rectangular parallelepiped shape (i.e., a suitable position for the gate position at the time of molding). FIG. 5 is a schematic perspective view of the container as seen from the bottom surface side.

As shown in FIG. 5, the container 2 is preferably located such that at least a portion of (and preferably all of) the gate mark of the container 2 which is centered on a corner 27 on the bottom surface 25 side of the container 2 is present in an area within one-sixth of a distance from the corner 27 on the bottom surface 25 side to an adjacent corner. More specifically, when the container has a rectangular parallelepiped shape, the points at which the distances from the corner 27 on the bottom surface 25 side to the three adjacent corners become one-sixth thereof (i.e., ⅙ W, ⅙ D and ⅙ H1) are each determined, and the gate mark of the container is more preferably located in an area surrounded by a circular arc or elliptical arc which is formed by connecting these points with archwires. Furthermore, when the container has a rectangular parallelepiped shape, the points at which the distances from the corner 27 on the bottom surface 25 side to the three adjacent corners become one-sixth are each determined, and the gate mark of the container is even more preferably located in an area surrounded by three triangles that are formed by connecting these points with straight lines.

In the drawing, a preferred area for positioning the gate mark in the container 2 is shown by the reference numeral 28. In FIG. 5, the width, depth and height of the container 2 are shown by the reference symbols W, D, and H1, respectively. More specifically, when the container has a rectangular parallelepiped shape with the width W of 5 to 500 mm, the depth D of 5 to 500 mm and the height H1 of 0.5 to 500 mm, the points at which the distances from the corner 27 on the bottom surface 25 side to the three adjacent corners become one-sixth thereof, that is, the points at which ⅙ W, ⅙ D and ⅙ H1 will be ⅚ to 500/6 mm, ⅚ to 500/6 mm and 0.5/6 to 500/6 mm, respectively, are each determined, and the gate mark of the container is more preferably located in an area surrounded by a circular arc or elliptical arc which is formed by connecting these points with archwires, and is particularly preferably located in an area surrounded by three triangles that are formed by connecting these points with straight lines.

In addition, the ratios of the width W to the depth D and the height H1 of the container are preferably W/D=0.2 to 5 and W/H1=0.5 to 20, respectively.

In the present description, the term “corner” refers to a corner that can be formed by the intersection of two ridge lines.

In the present description, the term “adjacent corners” refers to the corners that are adjacent, among the corners formed by the intersection of two ridge lines.

Further, FIG. 6 is a schematic diagram showing a suitable position for the gate mark of a lid exhibiting a rectangular parallelepiped shape (i.e., a suitable position for the gate position at the time of molding). FIG. 6 is a schematic perspective view of the lid as seen from the upper surface side.

As shown in the drawing, in the upper surface 33a and the lower surface 33b of the lid 3, a portion of (and preferably all of) the gate mark of the lid 3 which is centered on a corner 35 on the upper surface 33a side of the lid 3 is preferably present in an area within one-sixth of a distance from the corner 35 on the upper surface 33a side to an adjacent corner, and which is centered on a corner 36 on the lower surface 33b side of the lid 3, present in an area within one-sixth of a distance from the corner 36 on the lower surface 33b side to an adjacent corner, which is in an area surrounded by a circular arc or elliptical arc. Further, from the viewpoint of enhancing the airtightness, the gate mark of the lid is preferably present in an area other than the contact portion of the container and the lid (that is, an area other than the peripheral edge portion of the lid).

In the present description, the “circular arc” and “elliptical arc” are drawn so as to pass through two points at which a distance from one corner to the adjacent corner becomes one-sixth when the shape of the bottom surface is a polygonal shape, and, centered on that one corner, a circle is drawn when these distances are the same and an ellipse is drawn when these distances are different; and when the shape of the bottom surface is a circle or ellipse, centered on the end portion at which the gate mark is present or the shortest end portion, based on the length from that end portion to the farthest end portion, it is calculated based on the drawing of a circle centered on that end portion and having a diameter which is one-sixth of that length.

More specifically, in FIG. 5, when the width W and the depth D are of the same value, ⅙ W and ⅙ D will also be the same value. Therefore, in the bottom surface of the container, an area surrounded by a circular arc refers to an area surrounded by a circular arc which is part of a circle having a point 27 as the origin point and expressed by the expression: x²+y²=(⅙ W)².

The “x” and “y” can be determined by the following formula.

x=⅙W·cos θ, y=⅙W·sin θ, 0≦θ≦π/2 (Formula)

When the width W and the height H1 are of the same value, ⅙ W and ⅙ H1 will also be the same value. Therefore, in the outer surface of the container, an area surrounded by a circular arc refers to an area surrounded by a circular arc which is part of a circle having the point 27 as the origin point and expressed by the expression: x²+y² (⅙ W)².

The “x” and “y” can be determined by the following formula.

x=⅙W·cos θ, y=⅙W·sin θ, 0≦θ≦π/2 (Formula)

When the depth D and the height H1 are of the same value, ⅙ D and ⅙ H1 will also be the same value. Therefore, in the outer surface of the container, an area surrounded by a circular arc refers to an area surrounded by a circular arc which is part of a circle having the point 27 as the origin point and expressed by the expression: x²+y²=(⅙ D)².

The “x” and “y” can be determined by the following formula.

x=⅙D·cos θ, y=⅙D·sin θ, 0≦θ≦π/2 (Formula)

Further, when the width W and the depth D are of different values, in the bottom surface of the container, an area surrounded by an elliptical arc refers to an area surrounded by an elliptical arc which is part of an ellipse having the point 27 as the origin point and expressed by the expression: x²/(⅙ W)²+y²/(⅙ D)²=1.

The “x” and “y” can be determined by the following formula.

x=⅙W·cos θ, y=⅙D·sin θ, 0≦θ≦π/2 (Formula)

Further, when the width W and the height H1 are of different values, in the outer surface of the container, an area surrounded by an elliptical arc refers to an area surrounded by an elliptical arc which is part of an ellipse having the point 27 as the origin point and expressed by the expression: x²/(⅙ W)²+y²/(⅙ H1)²=1.

The “x” and “y” can be determined by the following formula.

x=⅙W·cos θ, y=⅙H1·sin θ, 0≦θ≦π2 (Formula)

Further, when the depth D and the height H1 are of different values, in the outer surface of the container, an area surrounded by an elliptical arc refers to an area surrounded by an elliptical arc which is part of an ellipse having the point 27 as the origin point and expressed by the expression: x²/(⅙ D)²+y²/(⅙ H1)²=1.

The “x” and “y” can be determined by the following formula.

x=⅙D·cos θ, y=⅙H1·sin θ, 0≦θ≦π/2 (Formula)

Further, in FIG. 6, when the width W and the depth D are of the same value, ⅙ W and ⅙ D will also be the same value. Therefore, in the upper surface and lower surface of the lid, an area surrounded by a circular arc refers to an area surrounded by a circular arc which is part of a circle having a point 35 as the origin point and expressed by the expression: x²+y²=(⅙ W)².

The “x” and “y” can be determined by the following formula.

x=⅙W·cos θ, y=⅙W·sin θ, 0≦θ≦π/2 (Formula)

Further, when the width W and the depth D are of different values, in the upper surface and lower surface of the lid, an area surrounded by an elliptical arc refers to an area surrounded by an elliptical arc which is part of an ellipse having the point 35 as the origin point and expressed by the expression: x²/(⅙ W)²+y²/(⅙ D)²=1.

The “x” and “y” can be determined by the following formula.

x=⅙W·cos θ, y=⅙D·sin θ, 0≦θ≦π/2 (Formula)

In addition, in a side surface 39 of the lid 3, at least a portion of (and preferably all of) the gate mark of the lid 3 is preferably present in an area within one-sixth of a distance from a ridge line connecting adjacent corners of the upper surface 33a and lower surface 33b of the lid 3 (for example, a ridge line indicated by the reference numeral 37) to an opposing ridge line.

More specifically, when the lid has a rectangular parallelepiped shape, at least a portion of (and preferably all of) the gate mark of the lid is preferably located: in the upper surface, the points at which the distances from a corner of the upper surface to the two adjacent corners of the upper surface become one-sixth thereof (i.e., ⅙ W and ⅙ D) are each determined, and in an area surrounded by a circular arc or elliptical arc which is formed by connecting these points with archwires; in the lower surface, the points at which the distances from a corner of the lower surface to the two adjacent corners of the lower surface become one-sixth thereof (i.e., ⅙ W and ⅙ D) are each determined, and in an area surrounded by a circular arc or elliptical arc which is formed by connecting these points with archwires; or, in the side surface, within an area, from a ridge line connecting the adjacent corners with each other that are the corners of the aforementioned upper surface and lower surface of the lid, to a straight line connecting the point in the upper surface described above and the point in the lower surface described above (that is, a straight line connecting the point at ⅙ W in the upper surface and the point at ⅙ W in the lower surface, and a straight line connecting the point at ⅙ D in the upper surface and the point at ⅙ D in the lower surface).

Furthermore, when the lid has a rectangular parallelepiped shape, at least a portion of (and preferably all of) the gate mark of the lid is more preferably located: in the upper surface, the points at which the distances from a corner of the upper surface to the two adjacent corners of the upper surface become one-sixth thereof are each determined, and in an area surrounded by a triangle which is formed by connecting these points with straight lines; in the lower surface, the points at which the distances from a corner of the lower surface to the two adjacent corners of the lower surface become one-sixth thereof are each determined, and in an area surrounded by a triangle which is formed by connecting these points with straight lines; or, in the side surface, within an area, from a ridge line connecting the adjacent corners with each other that are the corners of the aforementioned upper surface and lower surface of the lid, to a straight line connecting the point in the upper surface described above and the point in the lower surface described above.

In the drawing, a preferred area for positioning the gate mark in the lid 3 is indicated by the reference numeral 38 with oblique lines. In FIG. 6, the width, depth and height of the lid 3 are indicated by the reference symbols W, D, and H2, respectively.

More specifically, when the lid has a rectangular parallelepiped shape with the width W of 5 to 500 mm, the depth D of 5 to 500 mm and the height H1 of 0.2 to 20 mm, the gate mark of the lid is more preferably located: in the upper surface, the points at which the distances from a corner of the upper surface to the two adjacent corners of the upper surface become one-sixth thereof, that is, the points at which ⅙ W and ⅙ D will be 5/6 to 500/6 mm and 5/6 to 500/6 mm, respectively, are each determined, and in an area surrounded by a circular arc or elliptical arc which is formed by connecting these points with archwires; in the lower surface, the points at which the distances from a corner of the lower surface to the two adjacent corners of the lower surface become one-sixth thereof, that is, the points at which ⅙ W and ⅙ D will be 5/6 to 500/6 mm and 5/6 to 500/6 mm, respectively, are each determined, and in an area surrounded by a circular arc or elliptical arc which is formed by connecting these points with archwires; or, in the side surface, within an area, from a ridge line connecting the adjacent corners with each other that are the corners of the aforementioned upper surface and lower surface of the lid, to a straight line connecting the point in the upper surface described above and the point in the lower surface described above.

In addition, when the lid has a rectangular parallelepiped shape with the width W of 5 to 500 mm, the depth D of 5 to 500 mm and the height H1 of 0.2 to 20 mm, the gate mark of the lid is particularly preferably located: in the upper surface, the points at which the distances from a corner of the upper surface to the two adjacent corners of the upper surface become one-sixth thereof, that is, the points at which ⅙ W and ⅙ D will be 5/6 to 500/6 mm and 5/6 to 500/6 mm, respectively, are each determined, and in an area surrounded by a triangle which is formed by connecting these points with straight lines; in the lower surface, the points at which the distances from a corner of the lower surface to the two adjacent corners of the lower surface become one-sixth thereof, that is, the points at which ⅙ W and ⅙ D will be 5/6 to 500/6 mm and 5/6 to 500/6 mm, respectively, are each determined, and in an area surrounded by a triangle which is formed by connecting these points with straight lines; or, in the side surface, within an area, from a ridge line connecting the adjacent corners with each other that are the corners of the aforementioned upper surface and lower surface of the lid, to a straight line connecting the point in the upper surface described above and the point in the lower surface described above.

In addition, the ratios of the width W to the depth D and the height H1 of the lid are preferably W/D=0.2 to 5 and (the smaller value between W and D)/H1=2 to 50, respectively.

In the container 2 and the lid 3, when the gate marks are present in these positions in the container 2 and the lid 3, this means that the container 2 and the lid 3 have been injection-molded using a mold in which the gates are disposed at these positions. In such molded articles (the container 2 and the lid 3), in the top portion 24 of the container 2 and in the peripheral portion 32 of the lid 3, which are the portions where the container 2 and the lid 3 are welded, many portions are generated, in which the flow directions of the resins at the time of molding are the same direction, and the orientation directions of the resins are easily aligned with each other. For this reason, when the container 2 and the lid 3 are allowed to weld, the strength of the welded portion can easily be achieved, and, as a result, it is possible to configure a hollow molded article which is hardly damaged and exhibits high airtightness. Further, when molding is carried out by injecting a resin from the vicinity of a corner as described above, it is preferable if an outer shape of the intended hollow molded article is a rectangular parallelepiped shape, as in the present embodiment, since the orientation directions of the resins in a portion where the container 2 and the lid 3 are welded are easily aligned with each other.

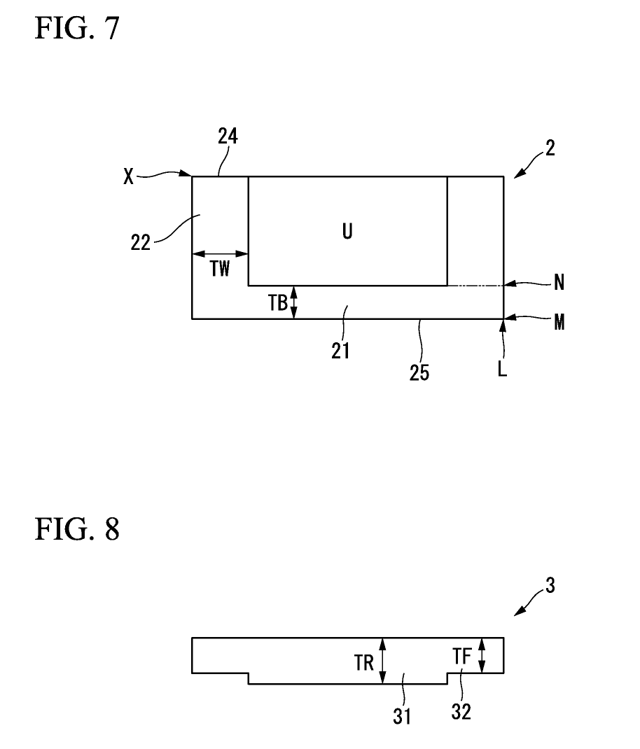

FIG. 7 is a schematic vertical cross-sectional view of the container 2. The gate position is determined according to the dividing position of the mold in the injection molding, and in the container 2 shown in the drawing, it is possible to illustrate the gates at positions for injecting a resin in a surface direction of the outer surface 29 of the side wall which is at an end portion of the bottom surface 25 (denoted by reference symbol L), in a bottom surface direction which is at an end portion of the bottom surface 25 (denoted by reference symbol M), and in a bottom surface direction which is at the same height as that of a surface on the accommodating space S side of the bottom portion 21 (denoted by reference symbol N). In addition, from the standpoint of causing the resin to flow in the surface direction of the top portion 24 in the top portion 24 of the side wall 22, the gate may be at a position for injecting a resin in the surface direction of the top portion 24 which is at the same height as that of the top portion 24 (denoted by reference symbol X).

In the container 2, it is preferable that an average thickness TB of the bottom portion 21 and an average thickness TW of the side wall 22 satisfy the relationship shown in the following formula (I):

4TB≧TW>¾TB (I).

TB and TW preferably satisfy the relationship: 4TB≧TW≧TB. When TB and TW satisfy the relationship: TW>¾ TB, it becomes difficult for the weld line to be located at the bottom portion 21 in the container 2, and it is possible to prevent the air leakage which is likely to occur due to the presence of the weld line at the bottom portion 21, and to obtain the desired orientation states of the resin. Further, if TB and TW satisfy the relationship: 4TB≧TW, warpage hardly occurs in the container 2.

FIG. 8 is a schematic vertical cross-sectional view of the lid 3. When a width of the top portion 24 of the side wall 22 shown in FIG. 7 is defined as LA, with respect to LA, a thickness TF of the peripheral portion 32 preferably satisfies the relationship: 0.2≦TF/LA≦1, more preferably 0.2≦TF/LA≦0.5. When TF/LA≧0.2, the strength of the obtained hollow molded article is sufficient. When TF/LA≦1, it is possible to suppress the attenuation of light quantity reaching the top portion 24 of the side wall 22. This is because a portion of the laser beam that transmits the peripheral portion 32 at the time of laser welding is scattered at the peripheral portion 32, and the component to be irradiated in a direction intersecting the light axis of the laser beam increases, but when TF/LA≦1, the laser beam is easily irradiated onto the top portion 24 before being spread even if the scattering occurred.

In the convex portion 31 which is not irradiated with laser light in the lid 3, it is preferable that an average thickness TR and a thickness TF of the peripheral portion 32 satisfy the relationship: 0.8≦TF/TR≦1.2. When TF/TR≦1.2, the welding strength and airtightness of the welded portion can easily be achieved, and when 0.8≦TF/TR, it is possible to suppress the occurrence of warpage in the lid 3.

The average thickness TB of the bottom portion 21 and the average thickness TW of the side wall 22 can be measured using a caliper, a micrometer, an optical length measuring machine, or by image analysis and the like.

The hollow molded article of the present embodiment is configured as described above.

A hollow molded article in the sixth aspect of the present application may be configured in the same manner as that of the hollow molded article in the first aspect described above.

### [Hollow Molded Article in the Fourth Aspect of the Present Invention]

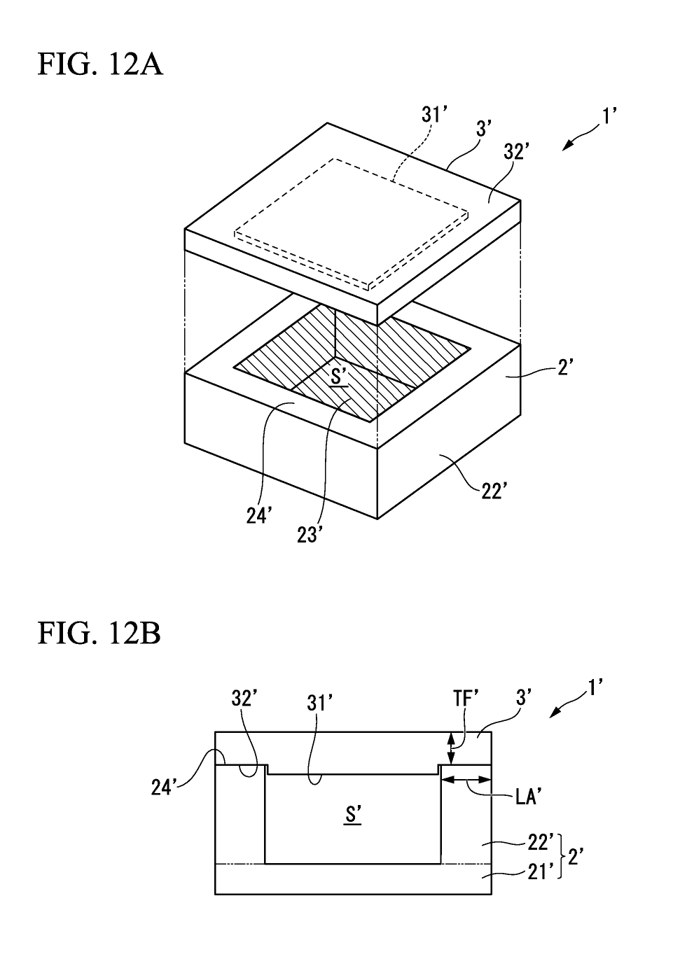

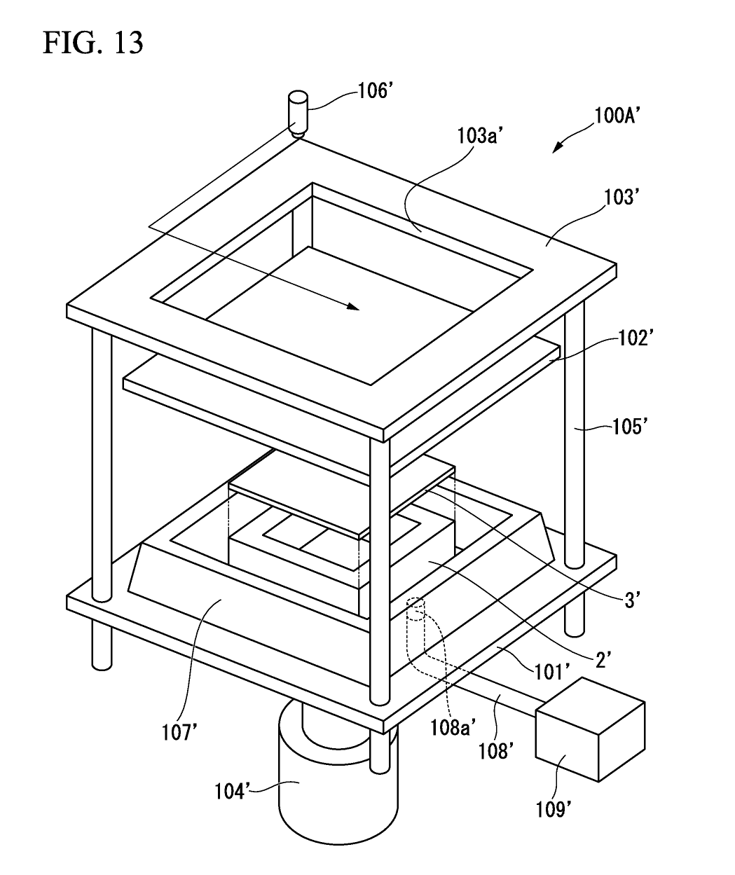

FIG. 12A and FIG. 12B are schematic diagrams showing an example of a hollow molded article of the fourth aspect of the present invention, and FIG. 12A is an exploded perspective view while FIG. 12B is a schematic vertical cross-sectional view. As shown in FIG. 12A and FIG. 12B, a hollow molded article 1′ includes a container 2′ and a lid 3′ which are formed by a known method such as injection molding. In the hollow molded article 1′ of the present embodiment, the container 2′ and the lid 3′ are joined by employing a laser welding method.

The container 2′ is a molded article surrounded by a bottom portion 21′ and a side wall 22′ that intersects the bottom portion 21′ and includes an accommodating space S′ in which an opening 23′ is formed on one surface. The shape of the container 2′ can be appropriately set in accordance with the shape of the components to be accommodated in the accommodating space S′. For example, in general, when accommodating a semiconductor device having a rectangular parallelepiped shape in the accommodating space S′, as shown in FIG. 12A and FIG. 12B, it is preferable to include the bottom portion 21′ of a rectangular parallelepiped shape and the side wall 22′ that is perpendicular thereto, and to configure the accommodating space S′ with a rectangular parallelepiped shape. In addition, a hollow molded article having a cylindrical outer shape or a prism outer shape may be configured. Furthermore, a hollow molded article having an outer shape of a truncated cone or polygonal frustum may be configured.

The container 2′ contains a coloring agent for absorbing laser light and converting the energy into heat.

Examples of the coloring agent include carbon black, monoazo dyes, anthraquinone dyes, perylene dyes, phthalocyanine dyes, nigrosine dyes, titanium black, black iron oxide, yellow iron oxide, red iron oxide, cadmium yellow, nickel titanium yellow, strontium yellow, aqueous chromium oxide, chromium oxide, cobalt aluminate and ultramarine blue, and one, or two or more types of these may be used. Among these, because of their high heat resistance, carbon black, titanium black and black iron oxide are preferred.

Such coloring agents are preferably contained in an amount of 0.01 to 10 parts by weight, and more preferably from 0.05 to 5 parts by weight, with respect to the total amount of the container 2′ (100 parts by weight).

Further, the container 2′ may contain inorganic fillers, various additives, or the like, as long as the effects of the present invention are not impaired.

It is also possible to embed a terminal for connecting the accommodating space S′ and the outside of the container 2′ in the side wall 22′ during injection molding of the container 2′. For example, it is possible to form the container 2′ having an external connection terminal by inserting a lead frame which is processed into a terminal shape in advance into a mold, followed by injection molding.

The lid 3′ is a plate-shaped molded body having the same shape as that of the container 2′ in plan view which is made with a light transmitting material as the forming material.

Here, in the present description, in the context of welding the container 2′ and the lid 3′ by employing a laser welding method, the expression “light transmitting” in the term “light transmitting material” refers to a state where the container 2′ exhibit a certain level of light transmittance so that when a laser beam for performing laser welding is transmitted, the laser beam can be irradiated thereto. Thus, even if a certain material is not a transparent material having a high light transmittance in the entire wavelength range, in relation to the wavelength of the laser beam to be used, when the material exhibits high light transmittance for light of this wavelength and is capable of forming the lid 3′ by irradiating the container 2′ with the laser beam, this material will be referred to as a “light transmitting material” in the present description. More specifically, the transmittance of laser light is preferably from 30 to 100% and more preferably from 50 to 100%. The aforementioned transmittance can be determined from the ratio of E2/E1, where E1 is an energy of a laser beam emitted from a laser oscillator which is measured using a power meter, and E2 is an energy measured by disposing a material so as to intersect the light between the laser oscillator and the power meter.

In FIG. 12A and FIG. 12B, like the container 2′ having a rectangular shape in a plan view, the lid 3′ has a rectangular shape in plan view. In addition, on the side facing the container 2′ in the lid 3′, a convex portion 31′ which fits in an opening 23′ of the container 2′ is provided in the central portion. In the drawing, the convex portion 31′ also has a rectangular shape in plan view in accordance with the shape of the opening 23′ of the container 2′.

In the present embodiment, although the shape of the lid 3′ in plan view is configured to be the same in response to the shape of the container 2′ in plan view and the shape of the opening 23′, the shapes of the container 2′ and the lid 3′ in plan view may be different. Further, the central portion of the lid 3′ may be raised upward or may be recessed.

Needless to say, a flat plate-shaped lid that does not have a convex portion 31′, like the lid 3′ shown in the drawing, may be used.

With respect to a width LA′ of the top portion 24′ of the side wall 22′, a thickness TF′ of a periphery of the convex portion 31′ (peripheral portion 32′) preferably satisfies the relationship: 0.2≦TF′/LA′≦1, more preferably 0.2≦TF′/LA′≦0.5. When TF′/LA′≧0.2, the strength of the obtained hollow molded article is sufficient. When TF′/LA′≦1, it is possible to suppress the attenuation of light quantity reaching the top portion 24′ of the side wall 22′. This is because a portion of the laser beam that transmits the peripheral portion 32′ at the time of laser welding is scattered at the peripheral portion 32′, and the component to be irradiated in a direction intersecting the light axis of the laser beam increases, but when TF′/LA′≦1, the laser beam is easily irradiated onto the top portion 24′ before being spread even if the scattering occurred.

The lid 3′ may contain inorganic fillers, various additives, or the like, as long as the effects of the present invention are not impaired.

With respect to the container 2′ and the lid 3′, the top portion 24′ and the peripheral portion 32′ are brought into contact while the convex portion 31′ of the lid 3′ is fitted into the opening 23′ of the container 2′, and the resulting contact portion is joined by employing a laser welding method. That is, in the method for manufacturing a hollow molded article according to the present embodiment, the contact portion of the container 2′ and the lid 3′ corresponds to an overlapping portion between the top portion 24′ and the peripheral portion 32′ when seeing the hollow molded article 1′ in plan view. Because both the upper surface of the top portion 24′ and the lower surface of the peripheral portion 32′ are horizontal planes (planes parallel with each other), the size and shape of the contact portion is consistent with the size and shape of the top portion 24′.

Examples of the materials for forming the container 2′ and the lid 3′ include resin materials having light transmittance, such as polystyrene resins, acrylic resins, polycarbonate resins, polyester resins, polyamide resins, polyacetal resins, polyphenylene ether resins, fluorine resins, polyphenylene sulfide resins, polysulfone resins, polyarylate resins, polyetherimide resins, polyether sulfone resins, polyether ketone resins, liquid crystalline polyesters, polyamideimide resins and polyimide resin, and among these, liquid crystalline polyesters are preferred since the fluidity, heat resistance, rigidity and gas barrier properties are favorable.

Examples of the liquid crystalline polyesters that can be used as the materials for forming the hollow molded article according to the fourth aspect of the present invention include the same liquid crystalline polyesters as those that can be used as the materials for forming the hollow molded article of the first aspect of the present invention described above.

In addition, in the fourth aspect of the present invention, as the material for forming the lid 3′, it is also possible to use an inorganic material having light transmittance.

Examples of the materials for forming the lid 3′ include glass such as soda lime glass, quartz glass, phosphosilicate glass, fluoride glass, lead glass, lanthanum glass, barium glass, borosilicate glass and aluminosilicate glass.

When the forming material of the lid 3′ is an inorganic material such as glass, it is preferable that the peripheral portion 32′ be surface-treated with one or more treatment agents selected from the group consisting of magnesium fluoride, zirconia and aluminum oxide, as long as the effects of the present invention are not impaired. For example, the surface treatment can be carried out by preparing a solution or dispersion in which a treatment agent has been dissolved or dispersed in a suitable solvent and applying the resultant by spin coating. Further, it is also possible to surface-treat the peripheral portion 32′ by using a target composed of a material constituting the treatment agent and performing a sputtering process or vapor deposition process.

More specifically, examples of the surface treatments with magnesium fluoride include a method in which a magnesium target is sputtered by using argon gas as a sputtering gas and a fluorine gas diluted with argon as a reaction gas, thereby depositing the gas generated by sputtering on the surface of the peripheral portion 32′, a method in which magnesium fluoride is used as a deposition material and is heated and deposited by irradiating an electron beam thereto, thereby depositing the evaporated gas on the surface of the peripheral portion 32′, and a method of applying a sol solution prepared with hydrofluoric acid and magnesium acetate onto the surface of the peripheral portion 32′ by spin coating or the like.

Examples of the surface treatments with zirconia include a method in which zirconia is used as a deposition material and is heated and deposited by irradiating an electron beam thereto, thereby depositing the evaporated gas on the surface of the peripheral portion 32′, and a method of applying a zirconium oxide sol by spin coating or the like.

Examples of the surface treatments with aluminum oxide include a method in which an aluminum target is sputtered by using argon gas as a sputtering gas and oxygen as a reaction gas, thereby depositing the gas generated by sputtering on the surface of the peripheral portion 32′, a method in which metallic aluminum is used as a deposition material and is heated by irradiating an electron beam thereto, thereby depositing the evaporated gas generated together with the oxygen gas on the surface of the peripheral portion 32′, and a method of applying an aluminum oxide sol by spin coating or the like.

In addition, when the forming material of the lid 3′ is an inorganic material such as glass, the peripheral portion 32′ may be subjected to a roughening treatment in order to improve the welding strength. For example, the roughening treatment can be carried out through a method of conducting an etching treatment with a mixed aqueous solution of chromic acid and sulfuric acid or an etching solution, such as hydrofluoric acid, or through a sandblasting process.

The surface treatment and roughening treatment of the peripheral portion 32′ as described above may be carried out in combination with each other.

Although the container 2′ and the lid 3′ are welded by at least partially melting the container 2′ when a laser welding method is employed, it is preferable that both of the materials for forming the container 2′ and the lid 3′ be thermoplastic resins in order to achieve a higher level of welding strength. In this case, it is preferable to use forming materials having the same melting point or flow-starting temperature for the container 2′ and the lid 3′, and it is more preferable to use the same material, apart from the presence or absence of the addition of coloring agents.

The hollow molded article of the present embodiment is configured as described above.

A hollow molded article in the ninth aspect of the present application may be configured in the same manner as that of the hollow molded article in the fourth aspect described above. [Method for Manufacturing a Hollow Molded Article in the Second Aspect of the Present Invention]

A method for manufacturing a hollow molded article in the second aspect of the present invention includes: a step of injection molding a container using a forming material containing a thermoplastic resin having a property of being oriented in a flow direction in a molten state and solidified; a step of injection molding a lid using a forming material containing a thermoplastic resin having a property of being oriented in a flow direction in a molten state and solidified; and a step of closing an opening of the container with the lid and laser welding a contact portion in which the container and the lid are brought into contact with each other, wherein the step of injection molding a container includes an injection molding of the container using a mold in which a gate position is set in such a manner that the entire gate mark of the container is located on an outer surface or bottom surface of the container, but, based on a distance from the center of gravity of the bottom surface of the container to an outer periphery of the bottom surface, is present in a position other than an area at two-thirds or less of the distance from the center of gravity, and the step of injection molding a lid includes an injection molding of the lid using a mold in which a gate position is set in such a manner that the entire gate mark of the lid is located on an upper surface, side surface or lower surface of the lid, but, based on a distance from the center of gravity of the upper surface of the lid to an outer periphery of the upper surface and a distance from the center of gravity of the lower surface of the lid to an outer periphery of the lower surface, is present in a position other than an area at two-thirds or less of the distance from the center of gravity of the upper surface and an area at two-thirds or less of the distance from the center of gravity of the lower surface.

First, as mentioned above, the container and the lid are formed by being injection molded from the gate which is set at a position other than the predetermined area. Subsequently, after bringing the obtained container and lid into contact so that the opening of the container is sealed with the lid, a contact portion is formed by laser welding.

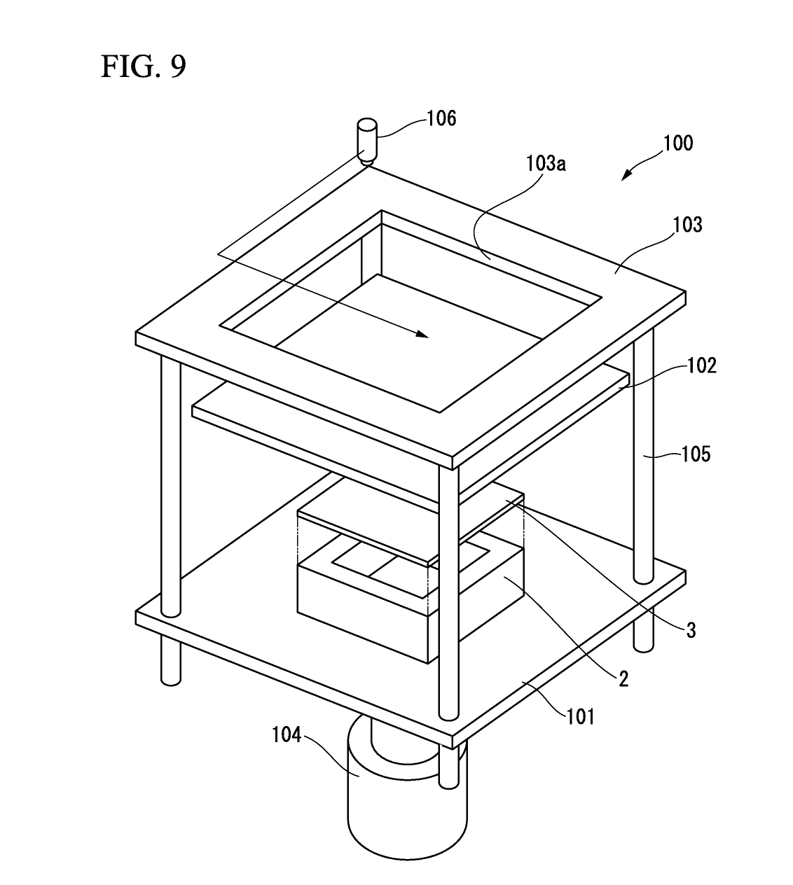

FIG. 9 is a schematic diagram illustrating a welding apparatus used in laser welding.

A welding apparatus 100 shown in the drawing is equipped with a mounting table 101 for mounting the container 2 and the lid 3 to be laser welded, a heat sink 102 that sandwiches the container 2 and the lid 3 with the mounting table 101, and a frame body 103 that includes an opening 103a and holds the heat sink 102. In the opening 103a of the frame body 103, a transparent member formed with a light transmitting material may be fitted.

The mounting table 101 is a plate-shaped member formed using a material, such as a metallic material and an inorganic material.

The heat sink 102 not only has a laser light transmittance to be described later of at least 50%, but also has a thermal conductivity of 1 to 200 W/in K. The heat sink 102 preferably has a laser light transmittance of 90 to 100%. In addition, the thermal conductivity is preferably from 5 to 200 W/mK. As the material for forming the heat sink 102 like this, for example, transparent alumina, transparent beryllia, transparent magnesium, quartz glass, sapphire and silicon can be mentioned.

Further, as the method of measuring the transmittance, determination from the ratio of E2/E1, where E1 is an energy of a laser beam emitted from a laser oscillator which is measured using a power meter, and E2 is an energy measured by disposing the heat sink between the laser oscillator and the power meter so as to intersect the light, and the like can be mentioned. Examples of the method of measuring the thermal conductivity include a laser flash method, an eye phase method and a temperature gradient method.

The mounting table 101 is provided so as to be freely and vertically movable by a lift 104, such as a spring and a hydraulic cylinder, and the mounting table 101 and the frame body 103 are connected through a plurality of (four in the drawing) support posts 105. In the drawing, the lift 104 is illustrated as a hydraulic cylinder.

Further, a laser light source 106 for emitting a laser beam is provided so as to be scannable in the horizontal direction, and is provided so that the laser beam can be emitted in the direction toward the mounting table 101 (downward direction). The laser light source 106 is preferably configured in such a manner that, by using an optical mirror, an optical fiber, lens, or the like, the transmission pathway of the laser light can be altered in accordance with the applications, so that the laser beam can be selectively irradiated onto a micro-region or the laser light can be irradiated while shifting the focal distance.

Examples of the type of laser beam irradiated from the laser light source 106 include gas lasers, such as a dye laser, an excimer laser, an argon laser, a krypton laser and a helium-neon laser, solid-state lasers, such as a ruby laser and a YAG laser, and semiconductor lasers. Among these, a laser beam having a wavelength within a range from 800 to 1,200 nm is preferred, since the container 2 and the lid 3 can be welded stably without deteriorating the container 2 and the lid 3.

Although a configuration in which the mounting table 101 connected with the lift 104 is being raised and/or lowered has been adopted in the welding apparatus 100 shown in the drawing, other configurations can also be adopted as long as the separation distance between the mounting table 101 and the heat sink 102 can relatively be altered. For example, a configuration in which the mounting table 101 is fixed, and the heat sink 102 and the frame body 103 are being raised and/or lowered may be adopted.

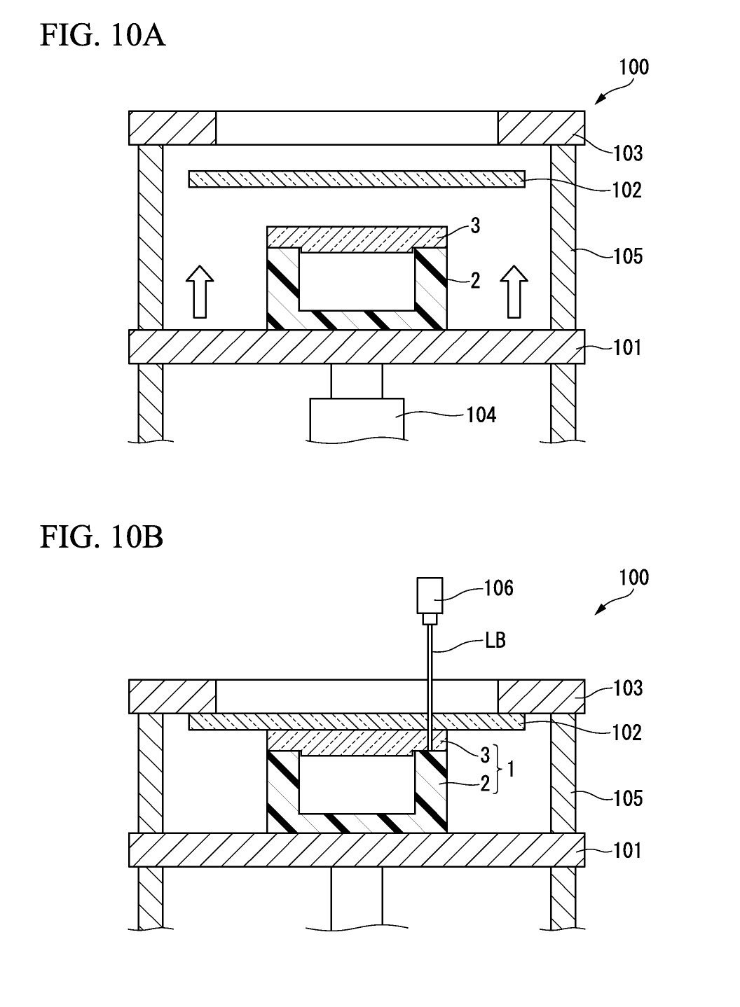

FIG. 10A and FIG. 10B are process diagrams of laser welding.

First, as shown in FIG. 10A, after accommodating a semiconductor device or the like in the accommodating space S of the container 2 if necessary, the container 2 and the lid 3 are superposed and mounted on the mounting table 101.

Subsequently, the mounting table 101 is raised by the lift 104. Due to the elevation of the mounting table 101, the lid 3 comes into contact with the heat sink 102, and the container 2 and the lid 3 are sandwiched and pressurized between the mounting table 101 and the frame body 103. As a result, the container 2 and the lid 3 come into close contact and are fixed. The pressure at this time is preferably from 0.01 to 10 MPa so as not to impair the shape of the container 2 and the lid 3. An elastic member formed with silicone rubber or the like may be sandwiched between the mounting table 101 and the container 2.

Then, as shown in FIG. 10B, a laser beam LB is irradiated onto the contact portion of the container 2 and the lid 3 from the laser light source 106. The energy of the laser beam LB is preferably from 1 to 100 W in order to suppress the decomposition, deterioration and deformation of the container 2. In addition, the scanning speed of the laser light source 106 is preferably from 2 to 30 mm/sec.

The laser beam LB passes through the lid 3 and irradiated onto the container 2. Since the container 2 contains a coloring agent that absorbs the laser beam LB and generates heat, when the laser beam LB is irradiated onto the contact portion with the lid 3 in the container 2, the contact portion is heated and the container 2 and the lid 3 are fused with each other. Thereafter, the fused resins are cooled and solidified, as a result of which the hollow molded article 1 of the present embodiment in which the container 2 is sealed with the lid 3 can be obtained.

At that time, in the contact portion of the container 2 and the lid 3 in the present embodiment, since the orientation directions of the resins are aligned in many parts, the strength of the welded portion is readily developed, and as a result, the hollow molded article 1 which is hardly damaged and exhibiting high airtightness can be configured.

The method for manufacturing a hollow molded article according to the second aspect of the present invention is configured as described above.

A method for manufacturing a hollow molded article in the seventh aspect of the present application may be configured in the same manner as that of the method for manufacturing a hollow molded article in the second aspect described above.

### [Method for Manufacturing a Hollow Molded Article in the Third Aspect of the Present Invention, and the Manufacturing Apparatus in the Fifth Aspect of the Present Invention]

FIG. 13 is a schematic diagram illustrating a manufacturing apparatus according to the fifth aspect of the present invention.

A manufacturing apparatus 100A′ shown in the drawing is equipped with a mounting table 101′ for mounting a container (object) 2′ and a lid (object) 3′ to be laser welded, a heat sink (heat dissipating member, a laser light transmitting portion) 102′ that sandwiches the container 2′ and the lid 3′ with the mounting table 101′, and a frame body (support) 103′ that includes an opening 103a′ and holds the heat sink 102′. A member having the heat sink 102′ and the frame body 103′ corresponds to an opposing member in the present invention. In the opening 103a′ of the frame body 103′, a transparent member formed with a light transmitting material may be fitted.

Here, the term “heat dissipating member” refers to a member having a thermal conductivity of at least 1 W/mK. More specifically, for example, it is formed from transparent alumina, transparent beryllia, transparent magnesium, quartz glass, sapphire and silicon.

The mounting table 101′ is a plate-shaped member formed using a material exhibiting low air permeability or no air permeability, such as a metallic material and an inorganic material.

The heat sink 102′ not only has a laser light transmittance to be described later of at least 50%, but also has a thermal conductivity of 1 to 200 W/mK. The heat sink 102′ preferably has a laser light transmittance of 90 to 100%. In addition, the thermal conductivity is preferably from 5 to 200 W/mK. As the material for forming the heat sink 102′ like this, for example, transparent alumina, transparent beryllia, transparent magnesium, quartz glass, sapphire and silicon can be mentioned.

Further, as the method of measuring the transmittance, determination from the ratio of E2/E1, where E1 is an energy of a laser beam emitted from a laser oscillator which is measured using a power meter, and E2 is an energy measured by disposing the heat sink between the laser oscillator and the power meter so as to intersect the light, and the like can be mentioned. Examples of the method of measuring the thermal conductivity include a laser flash method, an eye phase method and a temperature gradient method.

The mounting table 101′ is provided so as to be freely and vertically movable by a lift 104′, such as a spring and a hydraulic cylinder, and it is configured so that the separation distance between the mounting table 101′ and the heat sink 102′ and frame body 103′ (opposing member) can relatively be altered. The mounting table 101′ and the frame body 103′ are connected through a plurality of (four in the drawing) support posts 105′. In the drawing, the lift 104′ is illustrated as a hydraulic cylinder.

Further, a laser light source 106′ for emitting a laser beam is provided so as to be scannable in the horizontal direction, and is provided so that the laser beam can be emitted in the direction toward the mounting table 101′ (downward direction). The laser light source 106′ is preferably configured in such a manner that, by using an optical mirror, an optical fiber, lens, or the like, the transmission pathway of the laser light can be altered in accordance with the applications, so that the laser beam can be selectively irradiated onto a micro-region or the laser light can be irradiated while shifting the focal distance.

Examples of the type of laser beam irradiated from the laser light source 106′ include gas lasers, such as a dye laser, an excimer laser, an argon laser, a krypton laser and a helium-neon laser, solid-state lasers, such as a ruby laser and a YAG laser; and semiconductor lasers. Among these, a laser beam having a wavelength within a range from 800 to 1,200 nm is preferred, since the container 2′ and the lid 3′ can be welded stably without deteriorating the container 2′ and the lid 3′.

On the mounting table 101′, a wall material 107′ surrounding the periphery of an area for mounting the container 2′ and the lid 3′ in the mounting table 101′ in a ring-closing manner is provided. The wall material 107′ is open toward the heat sink 102′ and an opening of the wall material 107′ overlaps in plan view with the heat sink 102′.

The wall material 107′ is formed using an elastic material including synthetic rubber, such as silicone rubber, and natural rubber. As a result of the separation distance between the mounting table 101′ and the opposing member being narrowed, the wall material 107′ is sandwiched between them, thereby forming a work space surrounded by the mounting table 101′, the heat sink 102′ and the wall material 107′.

In addition, as a result of the separation distance between the mounting table 101′ and the heat sink 102′ being widened, the wall material 107′ is spaced apart from the heat sink 102′, and it becomes possible to take the container 2′ and the lid 3′, which are the objects of laser welding, in and out from the opening in the upper side of the wall material 107′.

The height of the wall material 107′ is set in consideration of the height of the container 2′ and the lid 3′, as the objects of laser welding, at the time of being superimposed (hereinafter, the height is described in the name of “reference height”).

When the height of the wall material 107′ is set higher than the reference height, by the pressure due to the wall material 107′ being sandwiched between the mounting table 101′ and the heat sink 102′, the wall material 107′ is deformed and attaches firmly to the mounting table 101′ and the heat sink 102′. As a result, it is easy to form a sealed work space.

In addition, if the container 2′ and the lid 3′ are deformed due to the pressure by being sandwiched between the mounting table 101′ and the heat sink 102′ and the gap between the mounting table 101′ and the heat sink 102′ becomes equal to or less than the reference height, it is also possible to set the height of the wall material 107′ to be lower than the reference height.

In this case, because the pressure of the mounting table 101′ and the heat sink 102′ is applied to the container 2′ and the lid 3′ first, it is easy to firmly adhere the container 2′ to the lid 3′.

More specifically, it is preferable that (height of the wall material):(reference height)=1.05:1 to 1.5:1.

The wall material 107′ may not be entirely formed of an elastic material. For example, only the upper end side of the wall material 107′ which comes into contact with the heat sink 102′ may be formed with an elastic material, while a portion that comes into contact with the mounting table 101′ may be formed with the same material (for example, a metallic material) as that of the mounting table 101′.

A through hole 108a′ that faces the work space surrounded by the mounting table 101′, the heat sink 102′ and the wall material 107′ and connects to the work space is provided in the mounting table 101′. A pressure reducing device 109′ is connected to the through hole 108a′ through a pipe 108′. As the pressure reducing device 109′, it is possible to use a generally known vacuum pump. It is preferable that the through hole be provided in the mounting table. More specifically, it is more preferable to be provided between the wall material 107′ and the container 2′ of the mounting table.

Although a configuration in which the mounting table 101′ connected with the lift 104′ is being raised and/or lowered has been adopted in the manufacturing apparatus 100A′ shown in the drawing, other configurations can also be adopted as long as the separation distance between the mounting table 101′ and the heat sink 102′ can relatively be altered. For example, a configuration in which the mounting table 101′ is fixed, and the heat sink 102′ and the frame body 103′ are being raised and/or lowered may be adopted.

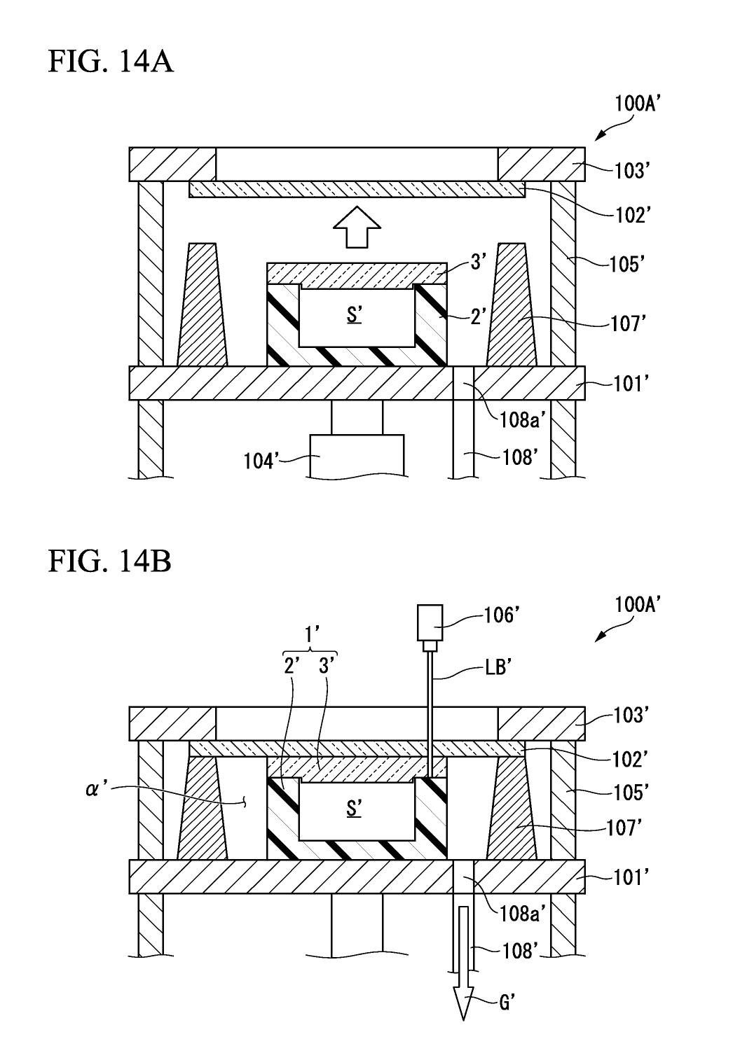

FIG. 14A and FIG. 14B are process diagrams of laser welding. First, as shown in FIG. 14A, after accommodating a semiconductor device or the like in the accommodating space S′ of the container 2′ if necessary, the container 2 and the lid 3 are superposed and mounted on the mounting table 101′.

Subsequently, the mounting table 101′ is raised by the lift 104′. Due to the elevation of the mounting table 101′, the lid 3′ comes into contact with the heat sink 102′, and the container 2′ and the lid 3′ are sandwiched and pressurized between the mounting table 101′ and the frame body 103′. As a result, the container 2′ and the lid 3′ come into close contact and are fixed. Further, at the same time, the wall material 107′ comes into close contact with the heat sink 102′ to form a work space surrounded by the mounting table 101′, the heat sink 102′ and the wall material 107′.

The pressure applied to the container 2′, the lid 3′ and the wall material 107′ at this time due to the elevation of the mounting table 101′ is preferably from 0.01 to 10 MPa so as not to impair the shape of the container 2′ and the lid 3′ and also in order to enhance the airtightness of the work space α′ (shown in FIG. 14B) to be formed. A base-like elastic member formed with silicone rubber or the like may be sandwiched between the mounting table 101′ and the container 2′.

If such an elastic member is included, even when the pressure applied to the container 2′ and the lid 3′ is too high, it is possible to relieve the pressure and to suppress the breakage of the container 2′ and the lid 3′.

Then, as shown in FIG. 14B, the work space α′ surrounded by the mounting table 101′, the heat sink 102′ and the wall material 107′ is degassed by using a pressure reducing device which is not shown via the through hole 108a′ and the pipe 108′. In the drawing, a gas to be discharged is indicated by an arrow G′. As a result, the pressure inside the work space α′ is reduced. Furthermore, the inside of the accommodating space S′ of the container 2′ is also degassed and depressurized from the gap slightly generated in the contact portion of the container 2′ and the lid 3′.

Then, a laser beam LB′ is irradiated onto the contact portion of the container 2′ and the lid 3′ from the laser light source 106′. The energy of the laser beam LB′ is preferably from 1 to 100 W in order to suppress the decomposition, deterioration and deformation of the container 2′. In addition, the scanning speed of the laser light source 106′ is preferably from 2 to 30 mm/sec.

The laser beam LB′ passes through the lid 3′ and irradiated onto the container 2′.

Since the container 2′ contains a coloring agent that absorbs the laser beam LB′ and generates heat, when the laser beam LB′ is irradiated onto the contact portion with the lid 3′ in the container 2′, the contact portion is heated and the container 2′ and the lid 3′ are fused with each other.

After laser welding the container 2′ and the lid 3′ by the irradiation of the laser beam as described above, the fused resins are cooled and solidified, as a result of which the hollow molded article l′ in which the container 2′ is sealed with the lid 3′ can be obtained.

The method for manufacturing a hollow molded article according to the present embodiment is configured as described above.

Since the accommodating space S′ is sealed in a state of reduced pressure in the hollow molded article 1′ obtained in this manner, as compared to the hollow molded article in which the accommodating space S′ is not depressurized, even when a heating treatment such as annealing and reflowing is carried out in the later production step, it is difficult to damage the accommodating space S′ because the pressure therein is less likely to become positive. Therefore, according to the method for manufacturing a hollow molded article as described above, it is possible to easily manufacture a hollow molded article exhibiting excellent airtightness and capable of maintaining a high level of airtightness even when subjected to a further heat treatment.

In addition, according to the hollow molded article having the above configuration, because it is produced by the method for manufacturing a hollow molded article described above, it is possible to provide a hollow molded article exhibiting excellent airtightness.

Further, according to the manufacturing apparatus having the above configuration, it is possible to manufacture a hollow molded article having excellent airtightness.

### Modified Example

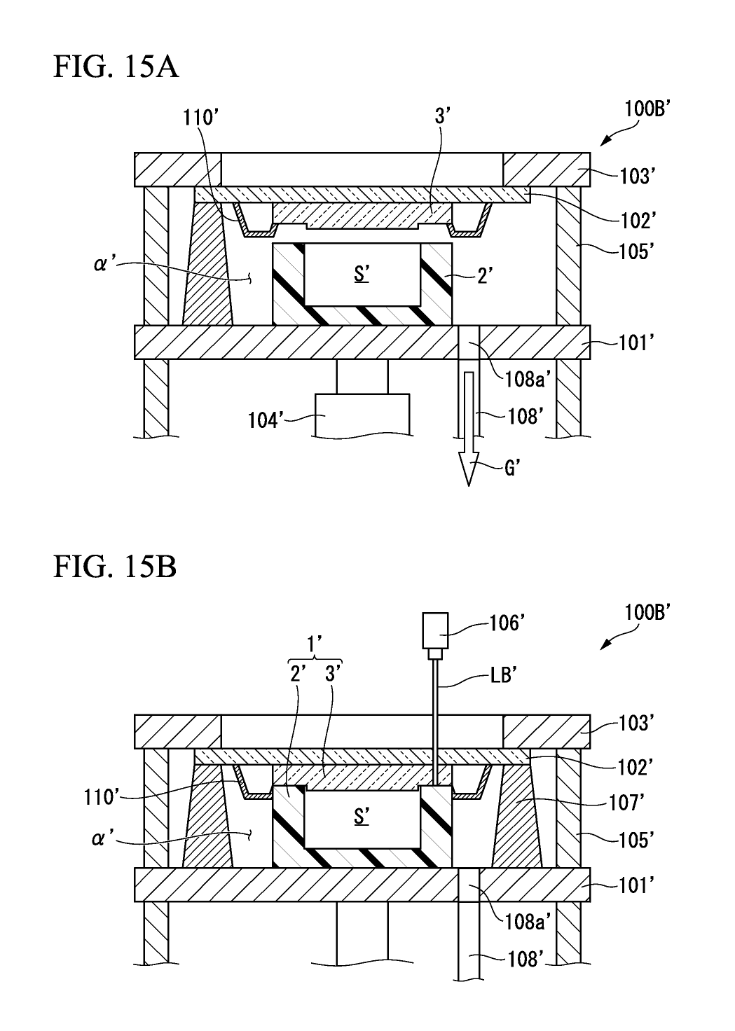

In the state shown in FIG. 14B, when a gap enough to perform degassing from the inside of the accommodating space S′ of the container 2′ is not formed in the contact portion of the container 2′ and the lid 3′, it is preferable to use a manufacturing apparatus 100B′ as shown in FIG. 15A and FIG. 15B. FIG. 15A and FIG. 15B are process diagrams of laser welding using the manufacturing apparatus 100B′, which are diagrams corresponding to FIG. 14A and FIG. 14B.

The manufacturing apparatus 100B′ shown in the drawing has a jig 110′ for holding the lid 3′ on a surface facing the mounting table 101′ in the heat sink 102′. The jig 110′ is, for example, a plate spring-shaped member which is bent into a hook shape, and it is possible to adopt a configuration for supporting the peripheral portion of the lid 3′ from below and retracting to the outside of the lid by a pressure applied from the container 2′ so as to release the lid 3′, when the container 2′ abuts due to the elevation of the container 2′. Alternatively, the configuration may be such that the side surface of the lid 3′ is support from the lateral direction.

When the manufacturing apparatus 100B′ is used, first, as shown in FIG. 15A, the mounting table 101′ is raised while the lid 3′ is held by the jig 110′ to bring the wall material 107′ into contact with the heat sink 102′, thereby forming a work space α′ surrounded by the mounting table 101′, the heat sink 102′ and the wall material 107′. In the manufacturing apparatus 100B′, the height of the wall material 107′ is set to be higher than the sum of the heights of the container 2′ and the lid 3′. For this reason, the lid 3′ held by the heat sink 102′ is able to form a work space a while not contacting the container 2′.

In this state, the work space α′ is degassed by using a pressure reducing device which is not shown via the through hole 108a′ and the pipe 108′. In the drawing, the air to be discharged is indicated by an arrow. As a result, the inside of the work space α′ is depressurized, and at the same time, the inside of the accommodating space S′ of the container 2′ is also degassed and depressurized.

Thereafter, as shown in FIG. 15B, due to further elevation of the mounting table 101′, the container 2′ and the lid 3′ are sandwiched and pressurized between the mounting table 101′ and the frame body 103′. As a result, the container 2′ and the lid 3′ come into close contact and are fixed while the pressure inside the accommodating space S′ is reduced.

Then, the laser beam LB′ is irradiated onto the contact portion of the container 2′ and the lid 3′ from the laser light source 106′ to perform laser welding. As a result, it is possible to produce the hollow molded article 1′ in which the accommodating space S′ is sealed while being depressurized.

According to the method for manufacturing a hollow molded article as described above, also, it is possible to easily manufacture a hollow molded article having excellent airtightness and which is capable of maintaining a high level of airtightness even when subjected to a heat treatment.

According to the hollow molded article having the above configuration, it is possible to provide a hollow molded article exhibiting high airtightness.

Further, according to the manufacturing method as described above, it is possible to easily manufacture a hollow molded article having high airtightness.

The hollow molded article of the present embodiment can be used as a case for storing a semiconductor device by encapsulating the semiconductor device in the accommodating space inside. Alternatively, it can also be used as a case for storing an electronic component, other than a semiconductor device, which includes sensors, such as an image sensor and an acceleration sensor, oscillators, and the like.

A method for manufacturing a hollow molded article in the eighth aspect of the present application may be configured in the same manner as that of the method for manufacturing a hollow molded article in the third aspect described above.

A manufacturing apparatus in a tenth aspect of the present application may be configured in the same manner as that of the manufacturing apparatus of the fifth aspect described above.

### EXAMPLES

As follows is a description of examples of the present invention. The present invention is not limited to these examples.

### Examples 1A to 6A, Comparative Examples 1A to 6A

A container was formed by injection molding a liquid crystalline polyester containing a coloring agent (SUMIKASUPER LCP E6808THF BZ, manufactured by Sumitomo Chemical Co., Ltd., flow starting temperature: 306° C., decomposition starting temperature: 499° C.), and a lid was formed by injection molding a liquid crystalline polyester which comprises no coloring agent (SUMIKASUPER LCP E6808THF Z, manufactured by Sumitomo Chemical Co., Ltd., flow starting temperature: 306° C., decomposition starting temperature: 499° C.). The shapes of the container and the lid were the same as those shown in FIG. 1A and FIG. 1B.

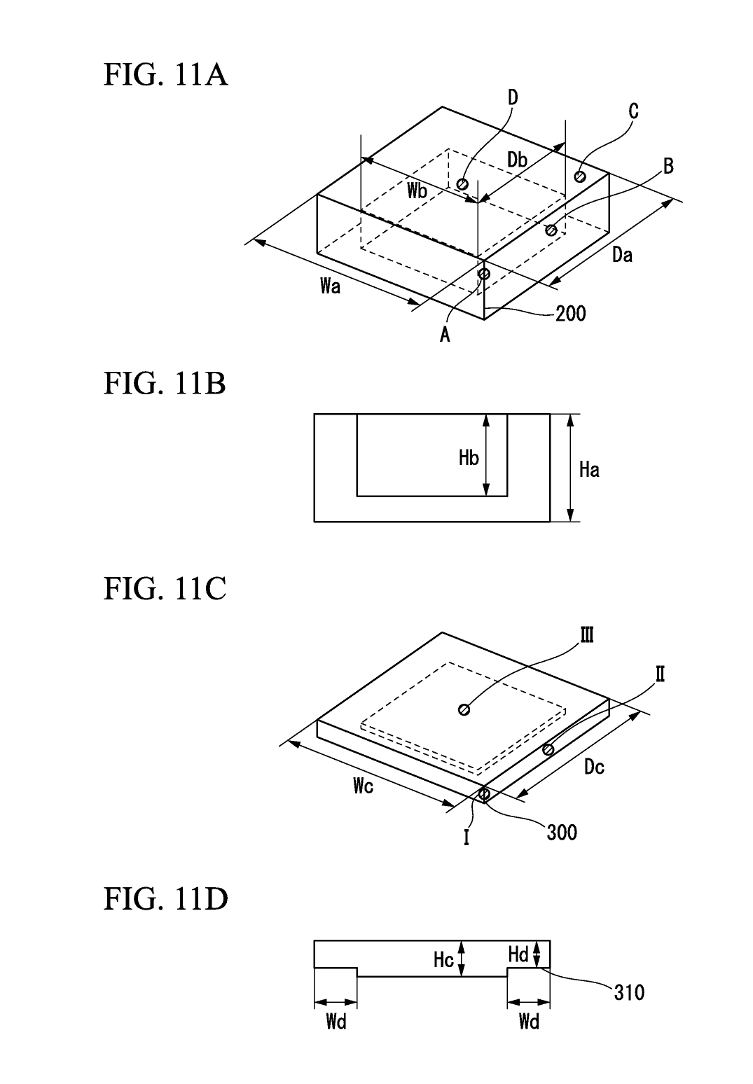

From FIG. 11A to FIG. 11D are schematic diagrams showing the shapes of the containers and lids molded in Examples and Comparative Examples. FIG. 11A is a schematic perspective view of the container as seen from the bottom surface side of the container, and FIG. 11B is a vertical cross-sectional view of the container. FIG. 11C is a schematic perspective view of the lid as seen from the upper surface side of the lid, and

FIG. 11D is a vertical cross-sectional view of the lid.

With regard to the dimensions of the produced container, external dimensions (Wa×Da×Ha) were 8.6 mm×8.6 mm×1.44 mm, while internal dimensions of the accommodating space (Wb×Db×Hb) were 6.8 mm×6.8 mm×0.94 mm.

The dimensions of the lid were a square of 9 mm×9 mm (Wc×Dc), while the thickness of the inner convex portion (He) was 0.35 mm, the thickness of the peripheral portion (Hd) was 0.3 mm, and the width (Wd) was 1.2 mm.

The container and the lid were mounted with sealing the container with the lid, on top of a mounting table of a welding apparatus. Further placing a heat sink made of quartz glass on the lid, the container, the lid and the heat sink were brought into close contact with each other by biasing a spring. To a contact portion of the container and the lid, a laser beam (wavelength: 940 nm, laser diameter at the focal point: 0.2 mm, laser output: 9.7 W) was irradiated from a laser oscillator (FD-200-50, manufactured by Fine device Co., Ltd.) with scanning at a speed of 10 mm/sec. At that time, the scanning was carried out with irradiating the laser beam in the manner that the center of the focus of the laser beam passed through a central line at the top portion of the side wall of the container.

Thereafter, the container and the lid were cooled to obtain a hollow molded article. A total of 10 hollow molded articles were produced.

The airtightness of the hollow molded articles was confirmed by the following method (bubble leak test).

### (Bubble Leak Test)

The hollow molded article was immersed in Fluorinert which was heated to 125° C. and then check the presence and absence of bubble generation during a period of 1 minute. The one was regarded as acceptable if there was no generation of bubbles. Those with a number of acceptable products of 0 to 3 were evaluated as “C”, those with a number of acceptable products of 4 to 6 were evaluated as “B”, those with a number of acceptable products of 7 to 10 were evaluated as “A”, and finally, those evaluated as “C” were regarded as unacceptable.

### Example 7A

Hollow molded articles were produced and the evaluation of airtightness was carried out in the same manner as in Example 1A, with the exception that the height (Ha) of the outer dimensions of the container was changed to 1.19 mm.

### Example 8A

Hollow molded articles were produced and the evaluation of airtightness was carried out in the same manner as in Example 1A, with the exception that the height (Ha) of the outer dimensions of the container was changed to 1.84 mm.

### Example 9A

Hollow molded articles were produced and the evaluation of airtightness was carried out in the same manner as in Example 1A, with the exception that the height (Ha) of the outer dimensions of the container was changed to 2.14 mm.

In Examples 1A to 9A and Comparative Examples 1A to 6A, the gate mark of the container was located at one of the positions indicated by the reference symbols A to D shown in FIG. 11A. More specifically, the gate positions indicated by the reference symbols A to D were located at the following positions. In addition, in the mold used for injection molding, the gate diameter was 0.3 mm.

A: Gate position which was set in the manner that the gate center was on a ridge of the container in the vertical direction (indicated by the reference numeral 200), and was at a position of 0.25 mm from the bottom surface of the container;

B: Gate position which was set in the manner that the gate center was at an intermediate position of the side wall of the container (a position separated from the ridge line 200 by ½ Da), and was at a position of 0.25 mm from the bottom surface of the container;

C: Gate position which was set in the manner that the gate center was in the vicinity of a corner of the bottom surface of the container, and was at a position where the distance from the two sides was 0.7 mm;

D: Gate position which was set in the manner that the gate center was at the center of the bottom surface of the container (that is, the center of gravity of the bottom surface of the container).

Further, in Examples 1A to 9A and Comparative Examples 1A to 6A, the gate position of the lid was located at one of the positions indicated by the reference symbols I to III shown in FIG. 11C. More specifically, the gate positions indicated by the reference symbols Ito III were located at the following positions. In addition, in the mold used for injection molding, the gate diameter was 0.2 mm.

I: Gate position which was set in the manner that the gate center was on a ridge of the lid in the vertical direction (indicated by the reference numeral 300), and was at a position of 0.15 mm above from a reference plane indicated by the reference numeral 310 in FIG. 11D;

II: Gate position which was set in the manner that the gate center was at an intermediate position of the side wall of the lid (a position separated from the ridge line 300 by ½ Dc), and was at a position of 0.15 mm from the reference plane 310;

III: Gate position which was set in the manner that the gate center was at the center of the upper surface of the lid (that is, the center of gravity of the upper surface of the lid).

In Examples 1A to 9A and Comparative Examples 1A to 6A, the results of the bubble leak test for the obtained hollow molded articles are shown in Table 1.

TABLE 1

| | Container | | | | Lid | | |
|---|---|---|---|---|---|---|---|
| | | Average | Average | | | Number | |
| | | thickness | thickness | | | of | |
| | Gate | (bottom | (side wall | TW/ | Gate | acceptable | |
| | mark | portion TB) | TW) | TB | mark | products | Evaluation |
| Ex. 1A | A | 0.5 | 0.9 | 1.8 | I | 10 | A |
| Ex. 2A | A | 0.5 | 0.9 | 1.8 | II | 9 | A |
| Comp. Ex. 1A | A | 0.5 | 0.9 | 1.8 | III | 0 | C |
| Ex. 3A | B | 0.5 | 0.9 | 1.8 | I | 9 | A |
| Ex. 4A | B | 0.5 | 0.9 | 1.8 | II | 8 | A |
| Comp. Ex. 2A | B | 0.5 | 0.9 | 1.8 | III | 0 | C |
| Ex. 5A | C | 0.5 | 0.9 | 1.8 | I | 9 | A |
| Ex. 6A | C | 0.5 | 0.9 | 1.8 | II | 9 | A |
| Comp. Ex. 3A | C | 0.5 | 0.9 | 1.8 | III | 0 | C |
| Comp. Ex. 4A | D | 0.5 | 0.9 | 1.8 | I | 0 | C |
| Comp. Ex. 5A | D | 0.5 | 0.9 | 1.8 | II | 0 | C |
| Comp. Ex. 6A | D | 0.5 | 0.9 | 1.8 | III | 2 | C |
| Ex. 7A | A | 0.25 | 0.9 | 3.6 | I | 10 | A |
| Ex. 8A | A | 0.9 | 0.9 | 1 | I | 9 | A |
| Ex. 9A | A | 1.2 | 0.9 | 0.75 | I | 4 | B |

As a result of the evaluation, as in Comparative Examples 1A to 6A, the airtightness was low in the hollow molded articles obtained by using any one of the members formed by the molding condition in which the gate mark was at the center of the bottom surface of the container (condition D) or the molding condition in which the gate mark was at the center of the upper surface of the lid (condition III).

In contrast, as in Examples 1A to 9A, it was found that the hollow molded articles obtained by using the containers with the gate mark satisfying any one of the conditions A to C, and the lids with the gate position satisfying any one of the conditions I and II, exhibited a high level of airtightness.

Furthermore, the hollow molded articles obtained in Examples 7A and 8A in which a thickness of the bottom portion (TB) and thickness of the side wall (TW) of the container satisfied a relationship (4TB≧TW≧TB) were found to have a higher airtightness than the hollow molded article of Example 9A that did not satisfy the relationship.

From these results, it was confirmed that the hollow molded articles of the present invention exhibit high airtightness, and it was found that the method for producing a hollow molded article according to the present invention is able to provide a hollow molded article with high airtightness.

### Example 1B

A container was formed by injection molding a liquid crystalline polyester which comprises a coloring agent (SUMIKASUPER LCP E6808THF BZ, manufactured by Sumitomo Chemical Co., Ltd., flow starting temperature: 306° C., decomposition starting temperature: 499° C.), and a lid was formed by injection molding a liquid crystalline polyester which comprises no coloring agent (SUMIKASUPER LCP E6808THF Z, manufactured by Sumitomo Chemical Co., Ltd., flow starting temperature: 306° C., decomposition starting temperature: 499° C.). The shapes of the container and the lid were the same as those shown in FIG. 12A and FIG. 12B.

The molded container had external dimensions of 8.6 mm×8.6 mm×1.44 mm and internal dimensions of a hollow portion of 6.8 mm×6.8 mm×0.94 mm.

In addition, the molded lid had dimensions of a square of 9 mm×9 mm in plan view, while the width of the peripheral portion was 1.2 mm, the thickness of the peripheral portion was 0.3 min, and the thickness of the convex portion was 0.35 mm.

The same apparatus as the production apparatus 100A′ shown in FIG. 13 was used as a production apparatus. The difference from the production apparatus 100A′ shown in FIG. 13 was that the mounting table was moved upward by loading with a spring instead of the lift 104′. In the following description, the same reference numerals shown in FIG. 13 will be used for the explanation.

In the manufacturing apparatus used in Examples, the wall material 107′ formed from silicone rubber (hardness 50°) was fixed on the mounting table 101′ with an adhesive. The height of the wall material 107′ was 3 mm.

A base made of silicone rubber (not shown in FIG. 13) was mounted on the mounting table 101′, and the container 2′ and the lid 3′ were mounted on the base by fitting the convex portion 31′ into the container 2′ and sealing the container 2′ with the lid 3′. When the base, the container 2′ and the lid 3′ were stacked, the total height was 3.7 mm.

The heat sink 102′ made of quartz glass was placed on the lid 3′, and the base, the container 2′, the lid 3′ and the heat sink 102′ were brought into close contact with each other, by biasing a spring. At the same time, the upper end of the wall material 107′ was brought into close contact with the heat sink 102′, thereby forming a work space surrounded by the mounting table 101′, the heat sink 102′ and the wall material 107′.

Thereafter, by operating a pressure reducing device (dry pump) which was connected via the through hole 108a′ of the mounting table 101′, the pressure of the work space was reduced to 20 KPa.

In a state of operating the dry pump, to a contact portion of the container 2′ and the lid 3′, a laser beam (wavelength: 940 nm, laser diameter at the focal point: 0.2 mm, laser output: 9.7 W) was irradiated from a laser light source 106 (FD-200-50, manufactured by Fine device Co., Ltd.) with scanning at a speed of 10 mm/sec.

Thereafter, the container and the lid were cooled to obtain a hollow molded article. A total of 10 hollow molded articles were produced.

The airtightness of the hollow molded articles was confirmed by the following bubble leak test.

In addition, changes in the airtightness after heating were confirmed, using the following reflow test, for the hollow molded articles which had passed the bubble leak test.

### (Bubble Leak Test)

The hollow molded article was immersed in Fluorinert which was heated to 125° C. and check the presence and absence of bubble generation during a period of 1 minute, and was regarded as acceptable if there was no generation of bubbles. Those with a number of acceptable products of 0 to 3 were evaluated as “C”, those with a number of acceptable products of 4 to 6 were evaluated as “B”, those with a number of acceptable products of 7 to 10 were evaluated as “A”, and finally, those evaluated as “C” were regarded as unacceptable.

### (Reflow Test)

In a nitrogen atmosphere, after increasing the temperature from room temperature (23° C.) to 280° C. in 200 seconds, the hollow molded article was held for 10 seconds at 280° C., and the temperature was further lowered to 50° C. in 330 seconds. Thereafter, the above-mentioned bubble leak test was carried out again.

### Example 2B

Hollow molded articles were produced and the evaluation of airtightness was carried out in the same manner as in Example 1B, with the exception that the laser welding was carried out in an environment where the pressure was reduced to 50 KPa.

### Comparative Example 1B

Hollow molded articles were produced and the evaluation of airtightness was carried out in the same manner as in Example 1B, with the exception that the laser welding was carried out at atmospheric pressure (101.3 KPa).

In Examples 1B and 2B and Comparative Example 1B, the results of the bubble leak test and reflow test for the obtained hollow molded articles are shown in Table 2.

TABLE 2

| | | Bubble leak test | | Reflow test | | |
|---|---|---|---|---|---|---|
| | | Number | | Number | | |
| | Accommodating | of | | of | | |
| | space inner | acceptable | Eval- | acceptable | Eval- | Swelling |
| | pressure (KPa) | products | uation | products | uation | of lid |
| Ex. 1B | 20 | 10 | A | 10 | A | 0 |
| Ex. 2B | 50 | 10 | A | 10 | A | 0 |
| Comp. | 101.3 | 10 | A | 3 | B | 3 |
| Ex. 1B | | | | | | |

The evaluation results showed that the hollow molded articles obtained by the manufacturing methods in Examples 1B and 2B, in which the accommodating space S′ was depressurized, not only passed all the bubble leak tests before heating, but also passed all the reflow tests, and the airtightness was maintained even after heating.

In contrast, the hollow molded articles obtained by the production method of Comparative Example 1B, where the pressure in the accommodating space S′ was equal to atmospheric pressure, had passed all the bubble leak tests before heating, but the number of acceptable products decreased in the reflow test, and the airtightness decreased after heating. Moreover, the lids were swollen in all the hollow molded articles which had passed the reflow test. It is thought that the deformation occurred as a result of an increase in the internal pressure at the time of the reflow test.

From these results, it was confirmed that the method for producing a hollow molded article according to the present invention is able to provide a hollow molded article with high airtightness.

### INDUSTRIAL APPLICABILITY

According to the present invention, it is possible to provide a hollow molded article having high airtightness. In addition, it is possible to provide a method for manufacturing such a hollow molded article. Furthermore, it is possible to provide a manufacturing apparatus capable of manufacturing a hollow molded article having excellent airtightness.

### REFERENCE SIGNS LIST

1: Hollow molded article; 2: Container; 2x: Gate mark; 3: Lid; 3x: Gate mark; 21: Bottom portion; 22: Side wall; 23: Opening; 24: Top portion; 25: Bottom portion; 27: Corner; 28: Area; 29: Outer surface; 31: Convex portion; 32: Peripheral portion; 33a: Upper surface; 35, 36: Corner; 37: Ridge line; 38: Area; 39: Side surface; 100: Welding apparatus; 101: Mounting table; 102: Heat sink; 103a: Opening; 103: Frame; 104: Lift; 105: Support post; 106: Laser light source; AR1: Area; AR2: Area; G1: Center of gravity; G2: Center of gravity; L1: Distance; L2: Distance; S: Accommodating space; 1′: Hollow molded article; 2′: Container, 21′: Bottom portion; 22′: Side wall; 23′: Opening; 24′: Top portion; 3′: Lid; 31′: Convex portion; 32′: Peripheral portion; 100′: Welding apparatus; 101′: Mounting table; 102′: Heat sink; 103a′: Opening; 103′: Frame; 104′: Lift; 105′: Support post; 106′: Laser light source; 107′: Wall material; 108′: Pipe; 108a′: Through hole; 109′: Decompressor; 110′: Jig; S′: Accommodating space; α′: Work space

1. A hollow molded article comprising:
a container; and
a lid for sealing said container;
wherein said hollow molded article is formed by laser welding of said container and said lid;
said container and said lid are each an injected molded article of a formation material comprising a thermoplastic resin, and comprise gate marks that have been formed during injection molding;
said thermoplastic resin has a property of being solidified with being oriented in a flow direction in a molten state
the entire gate mark in said container is presented in an outer surface or bottom surface of said container, provided that the entire gate mark is present, based on a distance from the center of gravity of the bottom surface in said container to an outer periphery of said bottom surface, in a position other than an area within two-thirds or less of said distance from said center of gravity;
and the entire gate mark in said lid is presented in an upper surface, side surface, or lower surface of said lid, provided that the entire gate mark is present, based on a distance from the center of gravity of the upper surface in said lid to an outer periphery of said upper surface, in a position other than an area within two-thirds or less of said distance from the center of gravity of said upper surface as well as, based on a distance from the center of gravity of the lower surface in said lid to an outer periphery of said lower surface, in a position other than an area within two-thirds or less of said distance from the center of gravity of said lower surface.

2. The hollow molded article according to claim 1, wherein an average thickness TB of the bottom portion in said container and an average thickness TW of a side wall in said container satisfy the following formula (I):
4TB≧TW>¾TB (I).

3. The a hollow molded article according to claim 1, wherein said bottom surface has a polygonal shape,
at least one portion of the gate mark in said container is present in an area, taking a corner of the said bottom surface as the center thereof, within one-sixth of a distance from the corner of said bottom surface to an adjacent corner of said container,
at least one portion of the gate mark in said lid is present:
in an upper surface of said lid, in an area, taking a corner of said upper surface as the center thereof, within one-sixth of a distance from the corner of said upper surface to an adjacent corner of said lid;
in a lower surface of said lid, in an area, taking a corner of said lower surface as the center thereof, within one-sixth of the distance from a corner of said lower surface to an adjacent corner of said lid; or
in a side surface of said lid, in an area within one-sixth of a distance from a ridge line connecting adjacent corners of the upper and lower surfaces in said lid to an opposing ridge line.

4. The hollow molded article according to claim 1, wherein an outer shape is a rectangular parallelepiped shape.

5. The hollow molded article according to claim 1, wherein said thermoplastic resin is a liquid crystalline polyester.

6. A method for producing a hollow molded article comprising:
a step of injection molding into a container by using a forming material which comprises a thermoplastic resin having a property of being solidified with being oriented in a flow direction in a molten state;
a step of injection molding into a lid by using a forming material which comprises a thermoplastic resin having a property of being solidified with being oriented in a flow direction in a molten state; and
a step of closing an opening of said container with said lid and performing laser welding of a contact portion in which said container and said lid are brought into contact with each other;
said step of injection molding into a container including an injection molding into said container by using a mold in which a gate position is set in a manner where the entire gate mark in said container is present in an outer surface or bottom surface of said container, provide that, the entire gate mark is present, based on a distance from the center of gravity of the bottom surface in said container to an outer periphery of said bottom surface, in a position other than an area within two-thirds or less of said distance from said center of gravity, and
said step of injection molding into a lid including an injection molding into said lid by using a mold in which a gate position is set in a manner where the entire gate mark of said lid is present in an upper surface, side surface, or lower surface of said lid, provide that, the entire gate mark is present, based on a distance from the center of gravity of the upper surface in said lid to an outer periphery of said upper surface, a position other than an area within two-thirds or less of said distance from the center of gravity of said upper surface, as well as, based on a distance from the center of gravity of the lower surface in said lid to an outer periphery of said lower surface, other than an area within two-thirds or less of said distance from the center of gravity of said lower surface.

7. A method for producing a hollow molded article comprising a step in which, using a container formed by molding a forming material which comprises a thermoplastic resin and a lid formed by molding a light transmitting material, in a state where an accommodating space surrounded by side walls and a bottom portion of said container is has been depressurized, laser welded is performed for sealing a contact portion where a top portion of said side walls and a peripheral portion of said lid are brought into contact, thereby obtaining a hollow molded article in a state where said accommodating space has been depressurized.

8. The method for producing a hollow molded article according to claim 7, wherein, following closing said container with said lid, a work space on which said container and said lid are mounted is depressurized and then the laser welding is performed for sealing with said accommodating space being depressurized.

9. The method for producing a hollow molded article according to claim 7, wherein, following sealing said container with said lid in an environment in which pressure is reduced in advance, laser welding is performed for sealing.

10. The method for producing a hollow molded article according to claim 1, wherein said thermoplastic resin is a liquid crystalline polyester.

11. The method for producing a hollow molded article according to claim 1, wherein said light transmitting material is a forming material which comprises a liquid crystalline polyester.

12. A hollow molded article produced by the method for producing a hollow molded article according to claim 7.

13. A production apparatus comprising: a mounting table for mounting an object to be subjected to laser welding;
a laser light source for emitting a laser beam on said object;
an opposing member facing said mounting table, which is movable for changing a separation distance from said mounting table;
a wall material surrounding an area for mounting said object on said mounting table, said wall material being formed by molding a forming material which comprises a resilient material into a closed circular shape, and said wall material being located between said mounting table and said opposing member;
and a pressure reducing device;
said opposing member being positioned so as to overlap with an opening of said wall material in plain view and being provided with a laser light transmitting portion which transmits said laser beam,
said mounting table and said opposing member, in a case of said separation distance being narrowed by moving said opposing member toward said mounting table, sandwiching said wall material, thereby forming a work space surrounded and sealed by said mounting table, said opposing member and said wall material,
a through hole which is connected to said work space and said pressure reducing device being provided in said mounting table, said opposing member or said wall material, and said pressure reducing device reducing the pressure of said work space through said through hole.

14. The manufacturing apparatus according to claim 13,
wherein said opposing member comprises a heat dissipating member, which is formed from a light transmitting material and provided in said laser light transmitting portion, and a support for supporting said heat dissipating member.

15. The manufacturing apparatus according to claim 13, wherein said opposing member comprises a jig for holding said object, on a surface facing said mounting table.
